(19) United States
(12) Patent Application Publication
(10) Pub. No.: US 2008/0186878 A1
(43) Pub. Date: Aug. 7, 2008

(54) MULTIMODE NETWORK COMMUNICATION SYSTEM

(75) Inventor: Ruobin Zheng, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/040,513

(22) Filed: Feb. 29, 2008

Related U.S. Application Data
(63) Continuation of application No. PCT/CN2006/002213, filed on Aug. 29, 2006.

(30) Foreign Application Priority Data
Sep. 1, 2005 (CN) 200510093679.4
Sep. 1, 2005 (CN) 200510093680.7
Sep. 1, 2005 (CN) 200510093681.1
Sep. 1, 2005 (CN) 200510093683.0

(51) Int. Cl. H04L 12/28

(52) U.S. Cl. 370/254

(57) ABSTRACT

A multimode network communication system includes first equipment based on a first mode and second equipment based on a second mode, and the second equipment includes a local device and a remote device, the local device being arranged in the first equipment and the remote device being independent of the first equipment. Further, according to the present invention the first and the second equipment may be wired or wireless equipment respectively. Therefore, in the situation that the first equipment is communication equipment in the original mode network and the second equipment is communication equipment in a new mode, the site for the first equipment may be configured to be shared by the remote device of the second equipment for the purpose of resources share, and the remote device of the second equipment may be arranged in an optimal site corresponding to the new mode.

### CROSS-REFERENCE TO RELATED APPLICATIONS

This application is a continuation of International Patent Application No. PCT/CN2006/002213, filed Aug. 29, 2006, which claims priority to Chinese Patent Application Nos. 200510093679.4, 200510093683.0, 200510093680.7, and 200510093681.1, filed Sep. 1, 2005, all of which are hereby incorporated by reference.

### FIELD OF THE INVENTION

The present invention relates to the network communication technology and in particular to a multimode network communication system.

### BACKGROUND OF THE INVENTION

With the development of the communication technology, networks deploying different modes are emerging, including wireless network in different modes and wired network in different modes. In order to integrate the advantages of networks in different modes and offer even better services, operators pursue to implement networking in accordance with networks in different modes, such as networking based on wireless network in different modes, wired network in different modes and integration of wireless network in different modes and wired network in different modes.

In the process of networking based on network in different modes, because the site selection for network equipment in different modes of networks is determined in accordance with the plan and optimization of network, there exists a situation that the site selection for network equipment in network in different modes is inconsistent, which brings inconvenience to networking based on network in different modes.

The problems of the existing networking based on network in different modes are further detailed as follows in conjunction with examples.

Networking based on wireless network in different modes

In a wireless communication system, for the purpose of employing wireless

access technology to cover a region, wireless network is required to be planned and optimized in accordance with geographical environment and wireless channel transmission environment of this region, so that the most reasonable location for a wireless base station may be determined.

For example, the site selection for the base station in a Global System for Mobile communications, GSM, wireless cellular network is shown in FIG. 1, and the site selection for the base station in a Worldwide Interoperability for Microwave Access, WiMAX, wireless cellular network is shown in FIG. 2. As illustrated, the site selection for the base station in wireless network in different modes varies.

Suppose that two wireless networks are to be constructed, i.e. a GSM wireless cellular network optimized with GSM wireless cellular network optimization method and a WiMAX wireless cellular network optimized with GSM WiMAX wireless cellular network optimization method, the optimized network is as shown in FIG. 3.

Suppose that Operator A constructs firstly a wireless cellular network covering a region by adopting mode A wireless access technology, for example GSM, and then desires to upgrade the original mode A wireless equipment (For example, a mode B wireless access card is inserted into the original mode A wireless base station.) into multimode wireless integrated access equipment, in the same region users adopting mode A wireless access technology are supported, users adopting mode B wireless access technology are introduced, and therefore a mode B wireless cellular network (for example WiMAX) overlaps the original mode A wireless cellular network.

However, as described above, the site selection for the original mode A wireless equipment is in conflict with that for the newly added mode B wireless base station due to the difference between the plan of cellular networks in different modes. As illustrated in FIG. 3, the distance between the optimal site of the original mode A wireless equipment and the optimal site of the newly added mode B wireless base station may be up to several kilometers. It is a problem whether to perform the site selection in accordance with mode A wireless network plan and place the upgraded multimode wireless integrated access equipment at the original site, or to perform another site selection in accordance with mode B wireless network plan. If the site selection is performed in accordance with mode A wireless network plan, it is an optimal site for mode A wireless cellular network but not an optimal site for mode B wireless cellular network. If the site selection is performed in accordance with mode B wireless network plan, it is an optimal site for mode B wireless cellular network but not an optimal site for mode A wireless cellular network and furthermore operators need to take the land on lease and construct machine rooms for the mode B wireless cellular network base station and mode A wireless cellular network equipment.

The mode B wireless base station may not be obtained by upgrading the mode A wireless equipment. Therefore, a new site selection needs to be performed for mode B wireless base station which also needs to be newly constructed.

Both the mode B wireless cellular base station and the mode A wireless cellular equipment need to be supplied with Alternating Current, AC, power, and provided with backup power supplies by using battery pack, Un-interruptible Power Supply, UPS, electric generator set or the second mains power. Operators usually need to take the land on lease and construct machine rooms for the mode B wireless cellular network base station and mode A wireless cellular network equipment. Therefore, if cable resources of the mode A wireless cellular network and the mode B wireless cellular network can not be efficiently utilized by sharing, it is difficult to uniformly maintain the mode B wireless cellular network base station and the mode A wireless cellular equipment, which may result in a high maintenance cost.

Networking based on wired network in different modes.

In construction of networking, for the purpose of employing wired access technology to cover a region, wired network is required to be planned and optimized in accordance with geographical environment and wireless channel transmission environment of this region, so that an optimal site for a wireless base station may be determined.

For example, in the situation that Digital Subscriber Line, DSL, broadband access network is constructed by adopting Asymmetric Digital Subscriber Line, ADSL, wired access technology, the site selection for the corresponding Digital Subscriber Line Access Multiplexer, DSLAM, equipment is as shown in FIG. 4. Similarly, if operators further desire to construct wired access network by adopting wired access technology in a new mode, for example by adopting Hybrid Fiber/Coax, HFC, wired access technology, the site selection for the corresponding access equipment is as shown in FIG. 5.

At present, if operators desire to construct networks by adopting two kinds of wired access technology, two wired access networks need to be constructed, i.e. a DSL broadband access network optimized with DSL broadband access network optimization method and an HFC wired access network optimized with HFC network optimization method.

Because the site selection for equipment during the networking plan based on different modes of wired access technology remains a problem, two wired access networks base on different modes of wired access technology need to be constructed. The details are as show in FIG. 6.

Suppose that Operator B constructs firstly a wired access network covering a region by adopting mode A (for example DSL) wireless access technology, and then desires to upgrade the original mode A wired equipment (For example, a mode B wired access card is inserted into the original mode A wired equipment.) into multimode wired integrated access equipment, in the same region users adopting mode A wireless access technology are supported, users adopting mode B wired access technology are introduced, and therefore a mode B wired access network (for example HFC) overlaps the original mode A wired access network. However, as described in FIG. 6, site selection for the original mode A wired equipment is in conflict with that for the newly added mode B wired equipment due to the difference between the plan of cellular networks in different modes. The distance between the optimal site of the original mode A wired equipment and the optimal site of the newly added mode B wired equipment may be up to several kilometers.

If the site selection for the upgraded multimode wired integrated access equipment is performed in accordance with mode A wired access network plan, it is an optimal site for mode A wired access network but not an optimal site for mode B wired access network. If the site selection is performed in accordance with mode B wired access network plan, it is an optimal site for mode B wired access network but not an optimal site for mode A wired access network.

In view of the above, in the existence of a wired access network, a new site selection needs to be performed if an access network based on a new wired access technology is to be constructed.

Both the mode A wired access equipment and the mode B wired access equipment need to be supplied with AC power, and provided with backup power supplies by using battery pack, UPS, electric generator set or the second mains power. Operators usually need to take the land on lease and construct machine rooms for the wired access equipment. Cable resources of the mode A wired access network and the mode B wired access network may not be efficiently utilized by sharing, and therefore it is difficult to uniformly maintain the mode B wired access equipment, which may result in a high maintenance cost.

Networking based on wireless network in different modes and wired network in different modes.

For the purpose of covering a region by adopting wireless access technology, for example WiMAX wireless access technology, wirelesss network is required to be planned and optimized in accordance with geographical environment and wireless channel transmission environment of this region, so that an optimal site for a wireless base station may be determined. As shown in FIG. 1, the site selection in Beijing is implemented through wireless access technology.

Similarly, for the purpose of covering a region by adopting wired access technology, for example ADSL wired access technology, wired network is required to be planned and optimized in accordance with geographical environment and wired channel transmission environment of this region, so that an optimal site for a wired base station may be determined. FIG. 2 illustrates the site selection for the wired equipment in Beijing by adopting wired access technology.

At present, if operators desire to construct networks by adopting wired access technology and wireless access technology, two access networks need to be constructed, i.e. a wired access network, for example DSL broadband access network, optimized with wired network optimization method; and a wireless access network, for example WiMAX cellular access network, optimized with wireless access network optimization method.

Because the site selection for equipment during the networking plan based on wireless access technology and that based on wired access technology remains a conflict, two access networks respectively based on wired access technology and wireless access technology need to be constructed. The details are as show in FIG. 3.

Suppose that Operator B constructs firstly a wireless access network covering a region by adopting wireless access technology, and then desires to upgrade the original wireless equipment into the wireless and wired integrated access equipment, for example adding a wired access card in the original base station, in the same region users adopting wireless access technology are supported, users adopting wired access technology are introduced.

However, as described in FIG. 6, site selection for the original wireless equipment is in conflict with that for the newly added wired equipment due to the difference between the plan of wireless network and that of wired network. The distance between the optimal site of the original wireless equipment and the optimal site of the newly added wired equipment may be up to several kilometers.

If the site selection for the upgraded wireless and wired integrated access equipment is performed in accordance with wireless access network plan, it is an optimal site for wireless access network but not an optimal site for wired access network. If the site selection is performed in accordance with wired access network plan, it is an optimal site for wired access network but not an optimal site for wireless access network. Furthermore, operators need to take the land on lease and construct machine rooms the wireless equipment and wired equipment.

In view of the above, in the case of the existence of a wireless access network, a new site selection needs to be performed if an access network based on a new wired access mode is to be constructed. The wired access network can not be constructed by upgrading the original wireless access network

If a new site selection is to performed for a new wired access network, both the wireless access equipment of wireless access network and the wired equipment of wired access network need to be supplied with AC power, and provided with backup power supplies by using battery pack, UPS, electric generator set or the second mains power. Operators usually need to take the land on lease and construct machine rooms for the equipment. The investment of the operators for constructing a new wired access network may be greatly increased.

If the wired access network can not be constructed by upgrading the original wireless access network, cable resources of wireless access network and the wired access network may not be efficiently utilized by sharing. Therefore it is difficult to uniformly maintain the wired access equipment and wireless access equipment, which may result in a high maintenance cost.

Similarly, in the case of the existence of a wired access network, the same problem may exist if an access network based on wireless access mode is to be constructed.

In conclusion, for the multimode network construction, there is no solution to the problem arising from the conflict of the site selection for equipment.

### SUMMARY OF THE INVENTION

The present invention provides a multimode network communication system so that different modes of network equipment newly added may effectively utilize the original network resources and the network maintenance and construction cost may be reduced.

A multimode network communication system includes first equipment based on a first mode and second equipment based on a second mode. The second equipment includes a local device and a remote device. The local device is arranged in the first equipment and the remote device is independent of the first equipment.

The multimode network communication system in accordance with the present invention further includes the following technical features.

The remote device is remotely connected with the local device via wired cables.

In the situation that the second equipment is wireless equipment, the local device includes a power supply unit and a base station access processing unit, and the remote device includes a base station outdoor unit; or the local device includes the power supply unit and the remote device comprises the base station outdoor unit and the base station access processing unit.

In the situation that the second equipment is wired equipment, the local device comprises the power supply unit and a wired access processing unit and the remote device comprises a wired terminal; or the local device comprises the power supply unit and the remote device includes the wired terminal and the wired access processing unit.

The power supply unit includes a central power supply unit and a power backup unit.

The remote device further includes a remote power supply unit; and the remote power supply unit is connected with the power supply unit arranged in the local device via the wired cables, and acquires electric energy to supply power for the remote device;

or, the remote power supply unit acquires local electric energy, and is connected with the base station outdoor unit or wired terminal arranged in the remote device via the wired cable, to supply power for the base station outdoor unit or wired terminal;

or, the remote power supply unit is connected with a next level remote device via the wired cables, to supply power for the next level remote device.

In the communication network system:

The central power supply unit is arranged in the first equipment to supply power for the first equipment, connected with the remote device via the wired cables to supply power for the remote device, and connected with the base station outdoor unit or wired terminal via the wired cables to supply power for the base station outdoor unit or wired terminal.

The power backup unit is arranged in the first equipment to be the backup power supply for the central power supply unit.

The local device and (or) the remote device further includes a convergence unit.

The convergence unit is arranged in the local device, adapted to converge and access signals received by the base station outdoor unit or wired terminal arranged in the remote device to the base station access processing unit or wired access processing unit arranged in the local device, and to send signal generated by the base station access processing unit or wired access processing unit arranged in the local device to the base station outdoor unit or wired terminal arranged in the remote device;

or, the convergence unit is arranged in the remote device and remotely connected with the base station access processing unit or wired access processing unit arranged in the local device via wired cables and connected with the base station outdoor unit or wired terminal arranged in the remote device, adapted to converge and access signals received by the base station outdoor unit or wired terminal arranged in multiple remote devices to the base station access processing unit or wired access processing unit arranged in the local device, and to send signal generated by the base station access processing unit or wired access processing unit arranged in the local device to the base station outdoor unit or wired terminal arranged in the remote device;

or, the convergence unit is arranged in the remote device and connected with the base station access processing unit or wired access processing unit arranged in the remote device via wired cables and remotely connected with the base station outdoor unit or wired terminal arranged in the remote device, adapted to converge and access signals received by the base station outdoor unit or wired terminal arranged in multiple remote devices to the base station access processing unit or wired access processing unit arranged in the remote device, and to send signal generated by the base station access processing unit or wired access processing unit arranged in the remote device to the base station outdoor unit or wired terminal arranged n the remote device.

In the multimode network communication system:

If the second equipment is a wireless equipment, the base station access processing unit includes: a wireless data upper link layer processing module and at least one of a wireless data link layer processing module, a base band processing module, an intermediate-frequency processing module and radio frequency post processing module; and

the base station outdoor processing unit includes: an antenna and a radio frequency pre-processing module, and at least one of the radio frequency post-processing module, the intermediate frequency processing module, the base band processing module and the wireless data link layer processing module.

In the multimode network communication system:

In the situation that the second equipment is wired equipment, the wired terminal is Integrated Access Equipment, IAD, with remote power supply, and the wired access processing unit is an Ethernet switch module; or the wired terminal is an Ethernet switch with remote power supply, and the wired access processing unit is a router module; or the wired terminal is an Optical Network Unit, ONU, with remote power supply, and the wired access processing unit is an Optical Line Terminal, OLT; or the wired terminal is a Digital Subscriber Line Access Multiplexer, DSLAM, compartment with remote power supply, and the wired access processing unit is a DSLAM access processing module.

In the situation that there are multiple base station access processing units or wired access processing units, each of the base station access processing units or wired access processing units communicates, via a switch convergence unit, with the base station outdoor unit or the wired terminal; and the base station access processing unit or wired access processing unit provides backup for each other on the base of the switch convergence unit.

In the multimode network communication system:

The switch convergence unit is arranged in the local device or remote device, adapted to converge and selectively access signals received by the base station outdoor unit or wired terminal arranged in the remote device to a base station access processing unit or wired access processing unit arranged in the local device or remote device, and to send signal generated by the base station access processing unit or wired access processing unit arranged in the local device or remote device to the base station outdoor unit or wired terminal arranged in the remote device;

or, two switch convergence units are respectively arranged in the local device and remote device, a first switch convergence unit arranged in the local device is remotely connected with a second switch convergence unit arranged in the remote device, and the second switch convergence unit is also remotely connected with the base station outdoor unit or the wired terminal. The second switch convergence unit is adapted to converge and send signals received by the multiple base station outdoor units or wired terminals arranged in the remote devices to the first switch convergence unit which selectively accesses the signals to one of the base station outdoor units or wired access processing units arranged in the local device; the first switch convergence unit is adapted to send signals generated by each of the base station access processing unit or wired access processing unit arranged in the local device to the second switch convergence unit which selectively accesses the signals to the one of the base station outdoor units or wired terminals arranged in the remote device.

If the second equipment is wireless equipment, the multiple base station outdoor units are configure into at least one multi-antenna transmit diversity or multi-antenna receive diversity in the situation that there are multiple base station outdoor units.

In the multimode network communication system in accordance with the present invention, the remote devices are interconnected with each other in star, ring or net structure in the situation that there are multiple remote devices.

The remote power supply units are connected with each other in star, ring or shared bus structure in the situation that the remote devices each includes a remote power supply unit.

The remote power supply units are adapted to provide backup connections to each other, and in the situation that the remote power supply unit of any one of the base station outdoor units or wired terminals fails, the base station outdoor unit or wired terminal is supplied with power by an available remote power supply unit after power switchover from a failed remote power supply unit to an available remote power supply unit is completed.

The first equipment is wired equipment or wireless equipment.

In the multimode network communication system:

In the situation that both the first equipment and the second equipment are wired equipment, the first equipment and the second equipment constitute a multimode wired network communication system;

in the situation that the first equipment is wired equipment and the second equipment is wireless equipment, or the first equipment is wireless equipment and the second equipment is wired equipment, the first equipment and the second equipment constitute a multimode wired and wireless network communication system; and

in the situation that both the first equipment and the second equipment are wireless equipment, the first equipment and the second equipment constitute a multimode wireless network communication system.

It can be seen from the above technical solutions that, in the multimode network communication system, the distributed equipment technology is adopted to arrange the local communication equipment in the newly added network into the communication equipment in the basic network, and to implement the service functions of the newly added network through message exchange with the remote communication equipment, which solves the problem of site selection conflict between the mode A equipment in the original network and the communication equipment in the newly added network due to the difference of multimode network plan.

Further, in the present invention, by adopting the remote power supply technique the equipment in the basic network and newly added network are supplied with power by the power supply unit in the basic network, which solves the problem that resources can not be fully utilized and reduces the maintenance cost.

For example, in the present invention, the operator A may select a site for the wired equipment in accordance with wired network plan, construct a wired access network. Then the operator A may select a site for the base station outdoor unit in accordance with demands for wireless access in the market and the wireless network plan. By upgrading the wired equipment, the base station access processing unit, convergence unit and remote power supply unit are added and interconnected with the base station outdoor unit, which constitutes complete wired and wireless integrated access equipment, helps constitute a wired and wireless access network in the same region and ensures an optimal plan for the wired and wireless networks. In the present invention, the base station remote equipment do not need AC power supply, do not need backup power supply by using battery pack, UPS, electric generator set or the second mains power. The base station remote equipment may be sealed and placed outdoor or underground and do not need machine rooms. Further, original cables, such as telephone twisted pair, of the fixed network operators may be reused for the wired and wireless base station remote equipment, which reduce the cost of network construction and maintenance.

In the present invention, the operator B may select a site for the wired equipment in accordance with mode A wired network plan, and construct a wired access network. Then the operator B may select a site for the mode B wired terminal in accordance with demands for wired access in the market and the mode B wired network plan. By upgrading the mode A wired equipment, the wired access processing unit, convergence unit and remote power supply unit are added and interconnected with the mode B wired terminal, which constitutes a complete multimode wired integrated access equipment, helps constitute a multimode wired access network in the same region and ensures an optimal plan for both the mode A wired and mode B wired networks. In the present invention, the mode B wired remote devices do not need AC power supply, do not need backup power supply by using battery pack, UPS, electric generator set or the second mains power. (Power backup is provided at the mode A wired equipment side) Therefore, the cost of construction and maintenance of the mode B wired network may be reduced.

### BRIEF DESCRIPTION OF THE DRAWINGS

FIG. 1 is a schematic diagram showing the base station site selection of the GSM wireless network plan.

FIG. 2 is schematic diagram showing the base station site selection of the WiMAX wireless network plan.

FIG. 3 is schematic diagram showing the conflict in the base station site selection of FIG. 1 and FIG. 2.

FIG. 4 is a schematic diagram showing the base station site selection of the DSL broadband access network plan.

FIG. 5 is a schematic diagram showing the base station site selection of the HFC wired access network plan.

FIG. 6 is a schematic diagram showing the conflict in base station site selection of the access equipment of FIG. 4 and FIG. 5.

FIG. 7 is a schematic diagram showing the base station site selection of the wireless network plan.

FIG. 8 is a schematic diagram showing the base station site selection of the wired network plan.

FIG. 9 is a schematic diagram showing the conflict in the base station site selection of FIG. 7 and FIG. 8.

FIG. 10 is a schematic diagram showing the base station.

FIG. 11 is schematic diagram 1 of the star structure showing the multimode wireless integrated access system.

FIG. 12 is schematic diagram 2 of the star structure showing the multimode wireless integrated access system.

FIG. 13 is schematic diagram 3 of the star structure showing the multimode wireless integrated access system.

FIG. 14 is schematic diagram 4 of the star structure showing the multimode wireless integrated access system.

FIG. 15 is schematic diagram 5 of the star structure showing the multimode wireless integrated access system.

FIG. 16 is schematic diagram 1 of the tree structure showing the multimode wireless integrated access system.

FIG. 17 is schematic diagram 2 of the tree structure showing the multimode wireless integrated access system.

FIG. 18 is schematic diagram 3 of the tree structure showing the multimode wireless integrated access system.

FIG. 19 is schematic diagram 4 of the tree structure showing the multimode wireless integrated access system.

FIG. 20 is schematic diagram 5 of the tree structure showing the multimode wireless integrated access system.

FIG. 21 is schematic diagram 1 of the ring structure showing the multimode wireless integrated access system.

FIG. 22 is schematic diagram 2 of the ring structure showing the multimode wireless integrated access system.

FIG. 23 is schematic diagram 3 of the ring structure showing the multimode wireless integrated access system.

FIG. 24 is schematic diagram 1 of the net structure showing the multimode wireless integrated access system.

FIG. 25 is schematic diagram 2 of the net structure showing the multimode wireless integrated access system.

FIG. 26 is schematic diagram 1 of the star structure showing the multimode wired integrated access system.

FIG. 27 is schematic diagram 2 of the star structure showing the multimode wired integrated access system.

FIG. 28 is schematic diagram 3 of the star structure showing the multimode wired integrated access system.

FIG. 29 is schematic diagram 4 of the star structure showing the multimode wired integrated access system.

FIG. 30 is schematic diagram 5 of the star structure showing the multimode wired integrated access system.

FIG. 31 is schematic diagram 1 of the tree structure showing the multimode wired integrated access system.

FIG. 32 is schematic diagram 2 of the tree structure showing the multimode wired integrated access system.

FIG. 33 is schematic diagram 3 of the tree structure showing the multimode wired integrated access system.

FIG. 34 is schematic diagram 4 of the tree structure showing the multimode wired integrated access system.

FIG. 35 is schematic diagram 5 of the tree structure showing the multimode wired integrated access system.

FIG. 36 is schematic diagram 1 of the ring structure showing the multimode wired integrated access system.

FIG. 37 is schematic diagram 2 of the ring structure showing the multimode wired integrated access system.

FIG. 38 is schematic diagram 3 of the ring structure showing the multimode wired integrated access system.

FIG. 39 is schematic diagram 1 of the net structure showing the multimode wired integrated access system.

FIG. 40 is schematic diagram 2 of the net structure showing the multimode wired integrated access system.

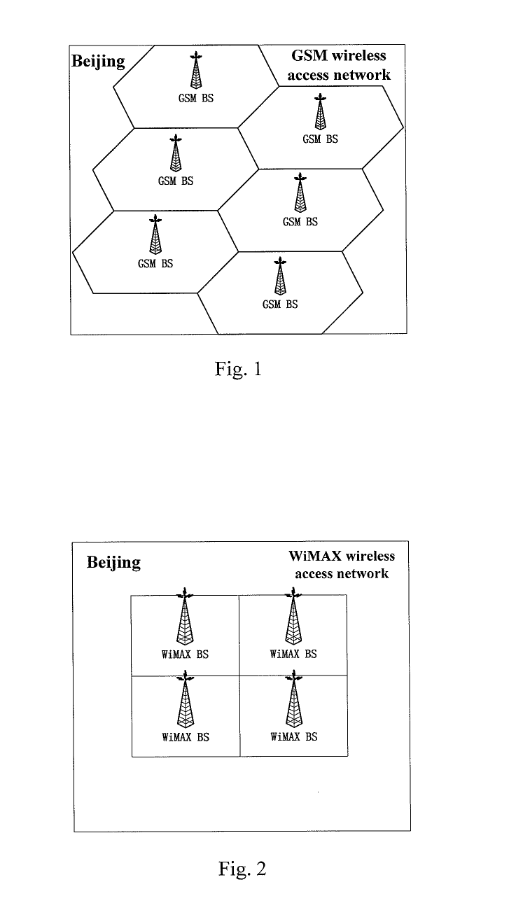

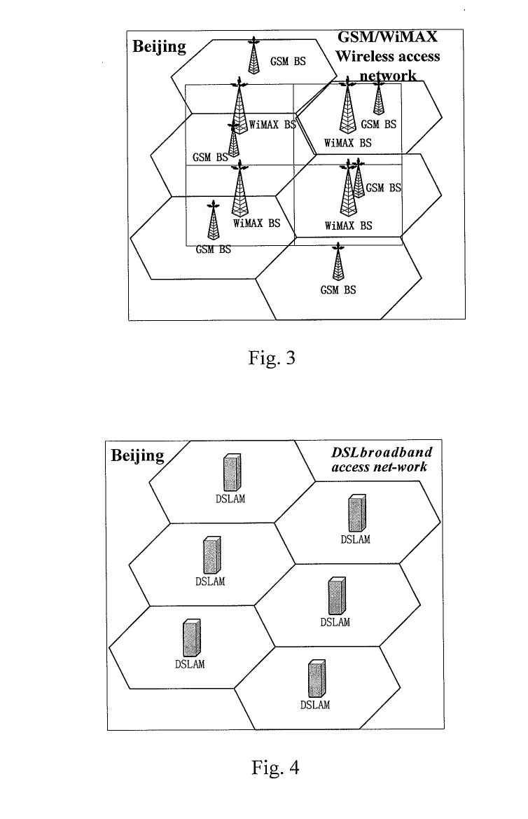

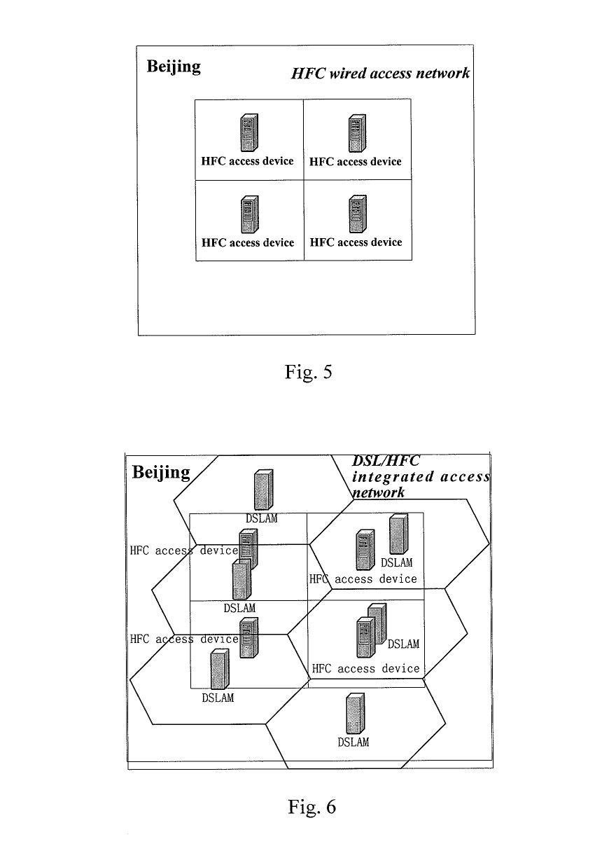

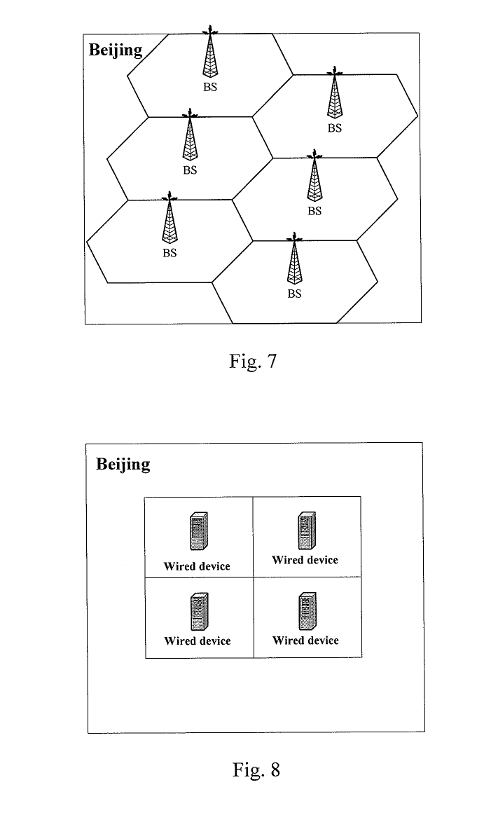

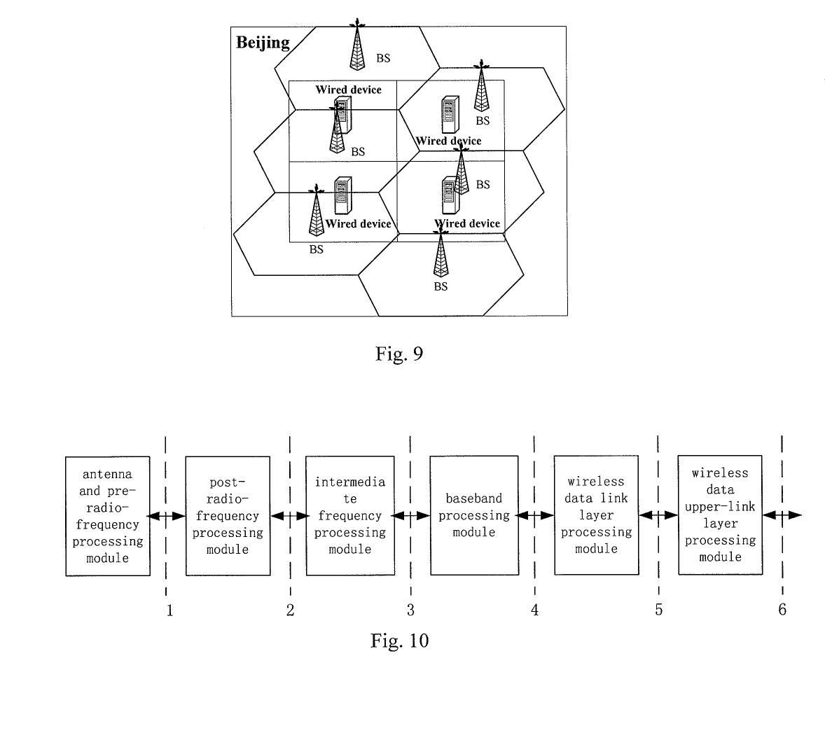

### DETAILED DESCRIPTION OF THE PRESENT INVENTION

The present invention is to solve the conflict in selecting site of networking in different modes.

The multimode network communication system of the present invention includes the first equipment based on the first mode and the second equipment based on the second mode. The second equipment includes local device and remote device; the local device is arranged in the first equipment so that the second equipment of the second mode may utilize the existing first equipment of the first mode to realize some functions. The remote device is independent and remotely connected with the first equipment, so as to satisfy the requirement of optimizing the site selection, overcoming the conflict occurring in selecting site of networking in different modes.

In the present invention, because the first equipment and the second equipment may be wired or wireless equipment respectively, the present invention may satisfy the requirements brought by wireless networking of different modes, wired networking of different modes, integrated wired and wireless networking of different modes.

The present invention provides respectively multimode wireless integrated access distributed system, multimode wired integrated access distributed system, and multimode wired and wireless integrated access distributed system, etc. The multimode wired and wireless integrated access distributed system may include the integrated access distributed system of the first equipment taking the wireless equipment as the first mode and the second equipment taking the wired equipment as the second mode, and the integrated access distributed system of the first equipment taking the wired equipment as the first mode and the second equipment taking the wireless equipment as the second mode.

The following is the detailed description of the embodiments of the present invention.

The present invention provides a multimode wireless integrated distributed system. The system may solve the conflict in selecting the site of the original mode A wireless equipment and the base station of a newly added mode B caused by the planning variance in the multimode wireless network. As a result, the resources may be fully utilized to lower the constructing and maintenance fee.

In the present invention, the key point of the system is to divide the newly added mode into two parts of local device and remote device. The local device is arranged in the existing wireless equipment, i.e. configured in the same site as that of the existing wireless equipment. The remote device may select the optimal site according to the network planning in the new mode; then the remote device is arranged in the optimal site to guarantee the best communication effect of the new mode network.

The newly added wireless equipment includes mainly base station equipment. As shown in FIG. 10, the base station equipment mainly includes antenna and pre-radio-frequency processing module, post-radio-frequency processing module, intermediate frequency processing module, baseband processing module, wireless data link layer processing module and wireless data upper-link layer processing module; meanwhile, base station equipment also needs the corresponding power supply unit to supply power.

Based on the base station structure, the local device in the system of the present invention includes at least power supply unit; and the base station access processing unit may also be included. The base station access processing unit includes the wireless data upper-link layer processing module, or the wireless data upper-link layer processing module and wireless data link layer processing module, or the wireless data upper-link layer processing module, the wireless data link layer processing module and baseband processing module, or the wireless data upper-link layer processing module, the wireless data link layer processing module, baseband processing module and intermediate frequency processing module, or wireless data upper-link layer processing module, wireless data link layer processing module, baseband processing module, intermediate frequency processing module and post-radio-frequency processing module.

Corresponding to the local device, the remote device, i.e. the remote base station equipment, includes base station outdoor unit which includes at least antenna and pre-radio-frequency processing unit and the processing units except that allocated to the local device. For example, when the local device includes the power supply unit, wireless data upper-link layer processing unit, wireless data link layer processing unit and baseband processing unit, the remote device then includes intermediate frequency processing unit, post-radio-frequency processing unit and antenna, and pre-radio-frequency processing unit.

In the present invention, the power supply unit is specifically the central power supply unit. The function is to transform the mains inputs (e.g. Alternating Current, (AC), 110V/220V) or the Direct Current, (DC), inputs (e.g. −48V/−60 DC) into high voltage DC outputs, in order to supply power to the local wireless equipment and local equipment, and also to supply power to the remote base station outdoor units through cable line (e.g. twisted pair cable). The distance of the remote power supply, which can be as far as 2˜5 kilometers, is affected by factors such as, the gauge of the wired cable, the number of the cable pairs, the power consumption of the outdoor units, and the output voltage of the power supply unit.

The central power supply unit also supports the communication between the base station outdoor units. As the out band management path, the central power supply unit may also implement monitoring alarm in both normal or fault state to facilitate the management of the equipment, fault positioning, remote maintenance, etc.

Additionally, in the present invention, the remote device may include the remote power supply unit, adapted to transform the high voltage DC inputs (e.g. 270V DC) into low voltage DC to supply power locally for the equipment where the remote power supply unit is arranged, or to continually transmit the high voltage DC from the central power supply unit and supply remotely the power for the next level remote base station outdoor units through the wired cable.

The system also includes a convergence unit, adapted to converge the wireless signal received by the base station outdoor processing unit and then access the signal to the base station access processing unit, distribute the signal generated by the base station access processing unit to the base station outdoor processing units and transmit the signal via antenna to wireless access users.

The convergence unit may be arranged in remote or local device. The following are descriptions concerning different situations.

When set in the local device, the convergence unit converges the wireless signal received by the base station outdoor unit of the remote device and then accesses the signal to the base station access processing unit of the local device, and transmits the signal generated by the base station access processing unit of the local device to the base station outdoor unit of the remote device.

When set in the remote device while the base station processing unit is set in local device, the convergence unit is remotely connected with the base station access processing unit of local device through the wired cable, and also remotely connected with the base station outdoor unit of the remote device, in order to converge the wireless access signal received by multiple base station outdoor units of remote device, and then transmit the signal to the base station access processing unit of the local device; and transmit the signal generated by the base station access processing unit of local device to the base station outdoor units of the remote device.

When set in the remote device while the base station processing unit is also set in the remote device, the convergence unit is connected with the base station access processing unit of the remote device through the wired cable, and is remotely connected with the base station outdoor unit of the remote device, in order to converge the wireless access signal received by multiple base station outdoor units of remote device, and then transmit the signal to base station access unit of the remote device; and transmit the signal generated by the base station access processing unit of remote device to the base station outdoor unit of the remote device.

When there are multiple base station processing units, the base station processing units communicate with the base station outdoor units through the switch convergence unit; the base station processing units may perform mutual aid in providing backup based on the switch convergence unit. The switch convergence unit is set in the local or the remote device; the unit converges the wireless access signal received by a base station outdoor unit of remote device, and then selectively accesses the signal to one of the base station access processing units of the local device or the remote device; and transmits the signal generated by the base station access processing unit of the local device or the remote device to the base station outdoor unit of the remote device.

The switch convergence units in the system of the present invention are set in both local device and remote device; the first switch convergence unit set in the local device is remotely connected with the second switch convergence unit set in the remote device; the second switch convergence unit is also remotely connected with the base station outdoor unit; the second switch convergence unit is adapted to converge the wireless access signal received by multiple base station outdoor units of the remote device and then transmit the signal to the first switch convergence unit; the first switch convergence unit selectively accesses one the base station processing unit of the local device; and transmits the signals generated by the base station processing units of the local device to the second switch convergence unit, then the unit selectively accesses one of the base station outdoor units of the remote device.

Embodiments of the multimode wireless communication system of the present invention will be described in detail in conjunction with the drawings. In the following embodiments, module A—wireless cellular network is taken as basic network; module B wireless cellular network is taken as newly-added network; the module A wireless cellular network equipment set in the basic network is taken as the local communication equipment; the rest module B wireless cellular equipment is taken as the remote communication equipment.

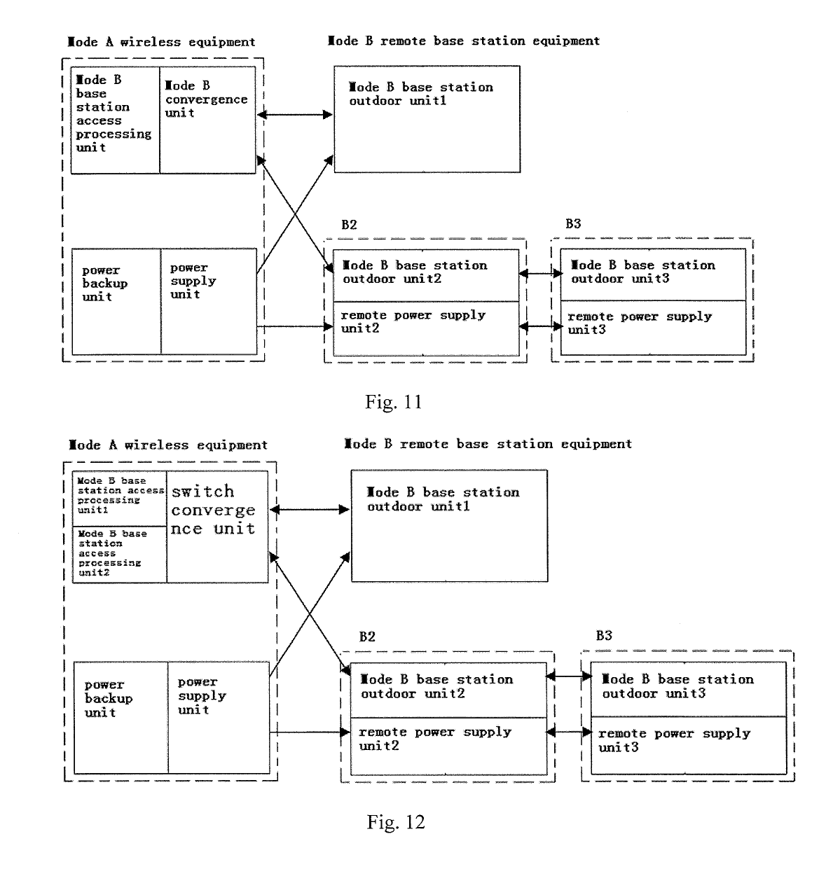

A first embodiment of the present invention is illustrated in FIG. 11.

This embodiment includes local module A wireless equipment, module B remote base station equipment, convergence unit, module B base station access processing unit, central power supply unit, remote power supply unit and power backup unit; the local module A wireless equipment includes the wireless equipment of the original module A wireless cellular network; the module B remote base station equipment includes specifically module B base station outdoor unit or the integrated equipment of the module B base station outdoor unit and the remote power supply unit.

In this embodiment, the module B base station access processing unit and convergence unit are set in the local module A wireless cellular equipment; the local module A wireless equipment is to optimize the site according to the module A wireless network plan; the module B outdoor unit is set in remote device according to the module B wireless network optimal site selection, and is remotely connected in star structure with the local module A wireless equipment via wired cable as fiber or twisted pair cable.

The module B base station outdoor units may be remotely interconnected via wired cable; multi-antenna transmit diversity or multi-antenna receive diversity may be constituted among multiple module B base station outdoor units. For example, as shown in FIG. 11, module B base station outdoor unit 2 and module B base station outdoor unit 3 are interconnected in concatenation, constituting dual antenna transmit diversity or dual antenna receive diversity.

In FIG. 11, the central power supply unit is set in local module A wireless cellular network to supply power for the module B base station access processing unit and the module B base station outdoor unit 2. The remote power supply unit 2 is remotely connected with the central power supply unit to supply power for the module B base station outdoor unit 2, and is also remotely connected with the lower level remote power supply unit 3 to supply the power for the first level module B base station outdoor unit 3.

The remote power supply unit is logically separated from the corresponding module B base station outdoor unit, but physically separated or integrated, like module B remote base station—B2 and B3.

In FIG. 11, the wired cable for connecting local module A wireless equipment and module B remote base station equipment and the cable is logically separated from the power cable, but physically separated or integrated. The star, ring, or shared bus connection may be adopted between the central power supply unit and module B base station outdoor units or remote power supply units. For example, as shown in the star connection in FIG. 11, the ring connection or the shared bus connection may also be adopted among remote power supply units.

The module B base station outdoor unit and the module B base station access processing unit complete together the wireless access processing, for example, the module B base station outdoor unit may include radio frequency, intermediate frequency and antenna; and, the base station access processing unit complete both the baseband and wireless data link layer processing.

The convergence unit converges the wireless access signal received by multiple module B base station outdoor units and then transmits the signal to module B base station access processing unit; and distributes the signal generated by the module B base station access processing unit to multiple module B base station outdoor units, and then transmits the signal to wireless access users via antenna.

The central power supply unit transforms the mains or DC inputs into high voltage DC outputs, and supply power for the remote module B base station outdoor unit via wired cable. The central power supply unit also supports the communication among the module B base station outdoor units. As the out band management path, the central power supply unit may also implement monitoring alarm in both normal or fault state to facilitate the management of the equipment, fault positioning, remote maintenance, etc.

In order to guarantee the power supply, the central power supply unit needs to be configured with the power supply unit to backup power. The power backup unit may be a battery pack, a UPS, a power generation set, or a second mains power.

A second embodiment is illustrated in FIG. 12.

As shown in FIG. 12, the difference between the system in FIG. 12 and the system in FIG. 11 lies in that the convergence unit in FIG. 11 is substituted by the switch convergence unit in FIG. 12, and the multiple mode B base station access processing units are added into the module A wireless equipment. The backup of “1+1” mode, “N+1” mode or a resource pool redundancy mode through the switch convergence unit may be made among the module B base station outdoor units of module A wireless equipment to further improve the reliability of the module B wireless network communication.

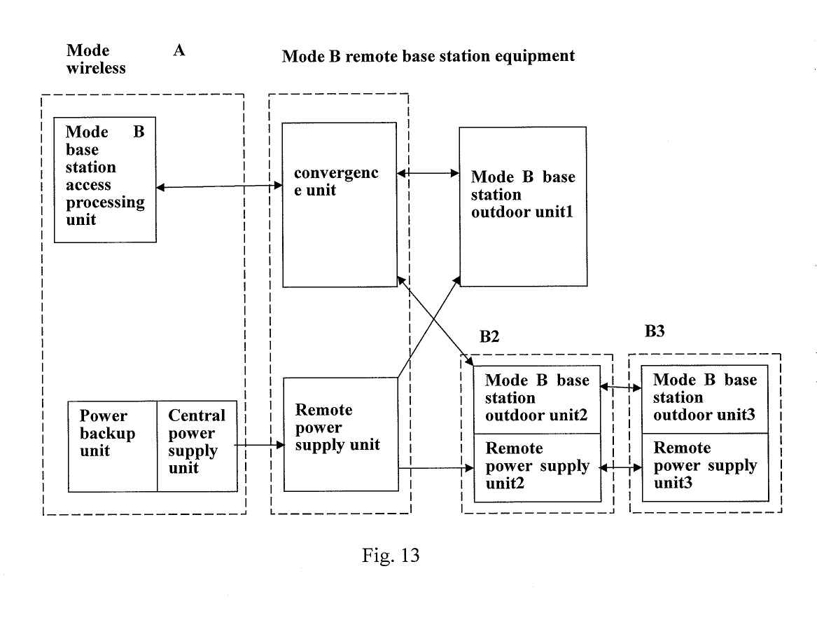

A third embodiment is illustrated in FIG. 13.

The difference of the system in FIG. 13 and the system in FIG. 11 lies in that the convergence unit of module A wireless equipment in FIG. 11 is set in the remote device of FIG. 13. The remote device includes convergence unit and remote power supply unit, and the convergence unit and the remote power supply unit may be simple switches capable of remote power supply, so that the connection between module A wireless equipment and module B base station outdoor units may be saved.

Module A wireless equipment is to optimize the site according to module A wireless network plan, while module B base station outdoor units are to optimize the site according to the module B wireless network plan. The module B base station outdoor unit is converged by the convergence unit, and is remotely connected with the module A wireless equipment via wired cable. The central power supply unit remotely supplies DC power for the module B base station remote equipment (2˜5 kilometers), similar to the remote power supply shown in FIG. 11; the remote power supply unit connected with the central power supply unit supplies power for the module B base station outdoor unit or the integrated equipment of module B base station outdoor unit and the remote power supply unit. The distance is within a certain range, such as 100-200 meters.

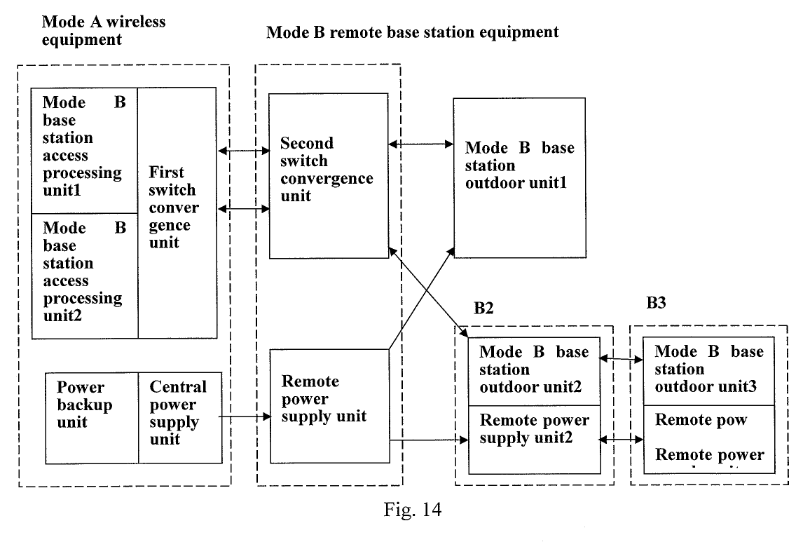

A fourth embodiment is illustrated in FIG. 14.

As shown in FIG. 14, the difference between the system in FIG. 14 and the system in FIG. 13 lies in that the convergence unit in FIG. 13 is substituted by the first and second switch convergence units in FIG. 14, and the module A wireless equipment is connected with remote device via multiple pairs of signals or data lines. The backup of “1+1” mode, “N+1” mode or a resource pool redundancy mode through the switch convergence unit may be made among the module B base station access processing units of module A wireless equipment, and the module B base station outdoor units, or of the signals or data lines between the module A wireless equipment and the second switch convergence unit to ensure the reliability of the module B wireless network communication.

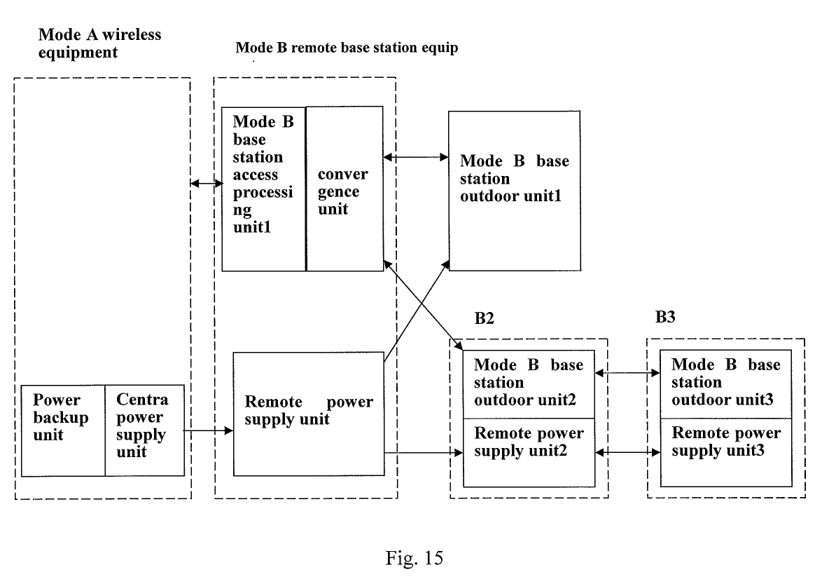

A fifth embodiment is illustrated in FIG. 15.

The difference of the system in FIG. 15 and the system in FIG. 13 lies in that the module B base station access processing unit of module A wireless equipment in FIG. 13 is set in the remote device in FIG. 15. The module B base station access processing unit, the switch exchange unit and the remote power supply unit in the remote device are integrated to be independent of the base station outdoor unit device.

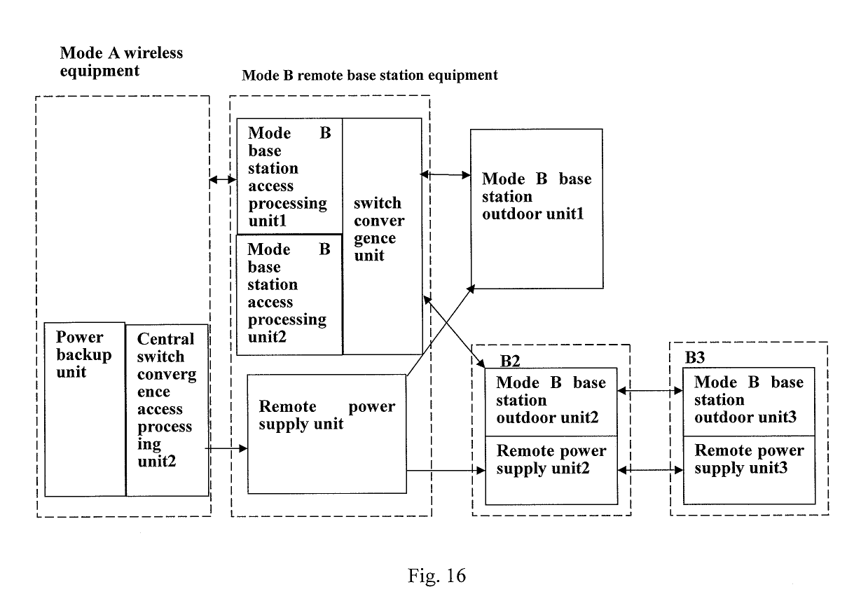

A sixth embodiment is illustrated in FIG. 16.

As shown in FIG. 16, the difference of the system in FIG. 16 and the system in FIG. 15 lies in that the convergence unit in FIG. 15 is substituted by switch convergence unit in FIG. 16, and the module B base station access processing unit is connected with the module B base station outdoor unit via multiple pairs of signal and data line. The backup of “1+1” mode, “N+1” mode or a resource pool redundancy mode through the switch convergence unit may be made among the mode B base station access processing units, and among the module B base station outdoor units.

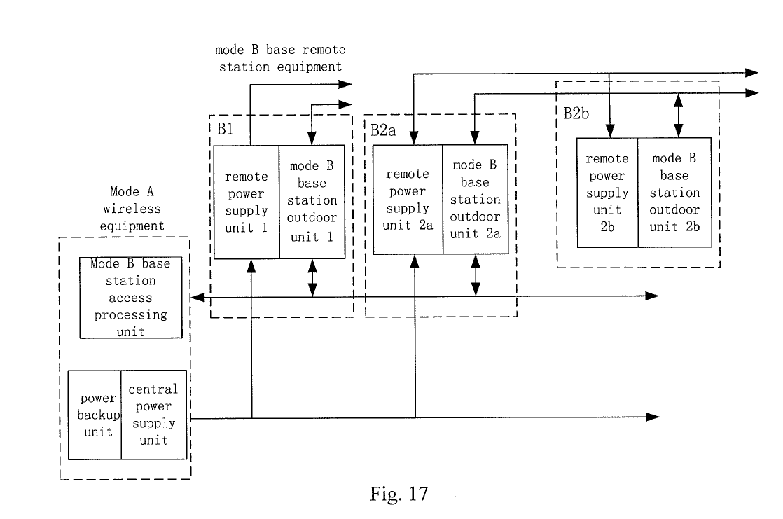

A seventh embodiment is illustrated in FIG. 17.

As shown in FIG. 17, the difference of the system in FIG. 17 and the system in FIG. 11 lies in that the remote tree connection is adopted between the module A wireless equipment in the system of FIG. 17 and the module B remote equipments. For example, module B base station outdoor unit 1 and module B base station outdoor units 2a share one wired cable using frequency division multiplexing or time division multiplexing, and then are remotely connected with module A wireless equipment; module B base station outdoor unit 2b is a branch from module B base station outdoor unit 2a, forming a remote tree connection.

The wired cable remotely connecting local module A wireless equipment and module B remote base station equipment, the corresponding signal line and power cable are logically separated but physically separated or integrated.

In FIG. 17, the star, ring or shared bus connection may be adopted between the central power supply unit and module B base station outdoor units; the star, ring or shared bus connection may be also adopted among the remote power supply units.

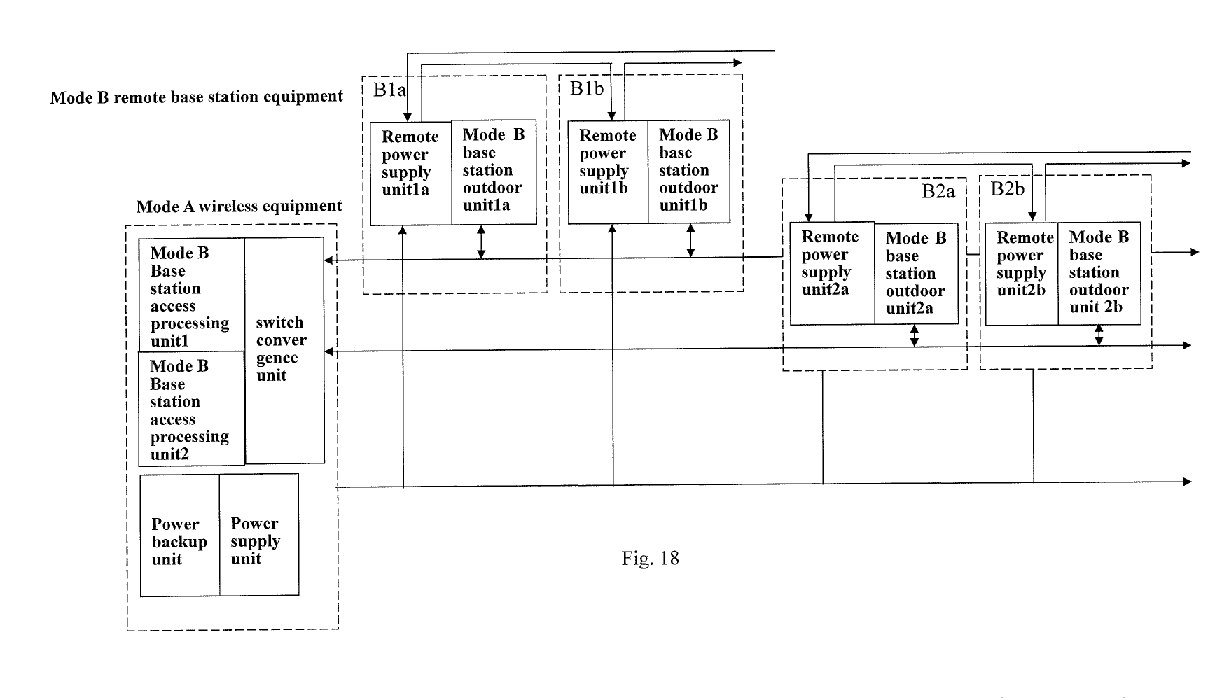

An eighth embodiment is illustrated in FIG. 18.

As shown in FIG. 18, the difference of system in FIG. 18 and the system in FIG. 17 lies in that multiple module B base station access processing units are added into the system of FIG. 18; multiple pairs of signal or data line tree connection is adopted between module A wireless equipment and module B base station remote equipment. The backup of “1+1” mode, “N+1” mode or a resource pool redundancy mode through the switch convergence unit may be made among the module B base station access processing units of module A wireless equipment or the module B base station outdoor units.

Similar to that in the system of FIG. 17, the star, ring or shared bus connection may be adopted between the central power supply unit and module B base station outdoor unit, or among the remote power supply units; the star, ring or shared bus connection may be also adopted among the remote power supply units.

In FIG. 18, in one branch or different branches, the power supply assistance may be implemented among remote power supply units. For example, the power assistance may be implemented between the remote power supply unit 1a and 1b of the same branch. When a fault occurs in the wired cable between the central power supply unit and remote power supply unit 1a, the remote power supply unit 1a may remotely supply power via the remote power supply unit 1b; however, when a fault occurs in the wired cable between the central power supply unit and remote power supply unit 1b, the remote power supply unit 1b may remotely supply power via the remote power supply unit 1a.

In one branch or different branches, multiple module B base station outdoor units may constitute multi-antenna transmit diversity or multi-antenna receive diversity. For example, in FIG. 18, module B base station outdoor units 1a and 1b may constitute bi-antenna transmit diversity or bi-antenna receive diversity; module B base station outdoor units 1a and 2a may also constitute bi-antenna transmit diversity or bi-antenna receive diversity; module B base station outdoor units 1a, 1b, 2a and 2b may constitute qua-antenna transmit diversity or qua-antenna receive diversity.

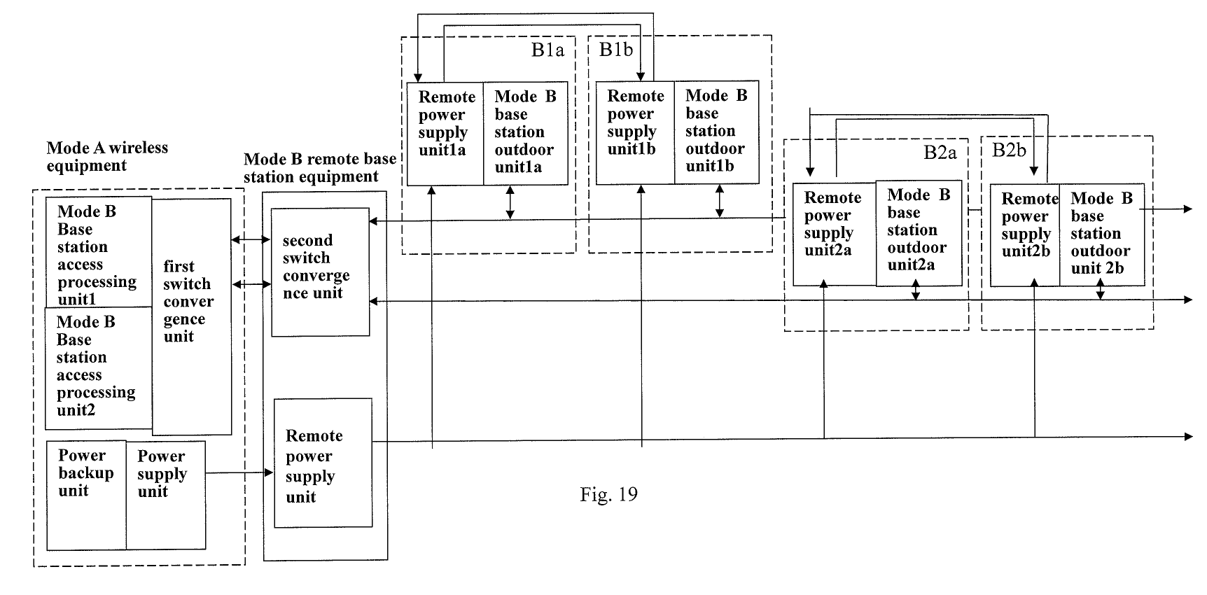

A ninth embodiment is illustrated in FIG. 19.

As shown in FIG. 19, the difference between the system in FIG. 19 and the system in FIG. 18 lies in that the switch convergence unit of the module A wireless device in FIG. 18 is set in the module B base station remote equipment of FIG. 19 as a part of the base station remote equipment.

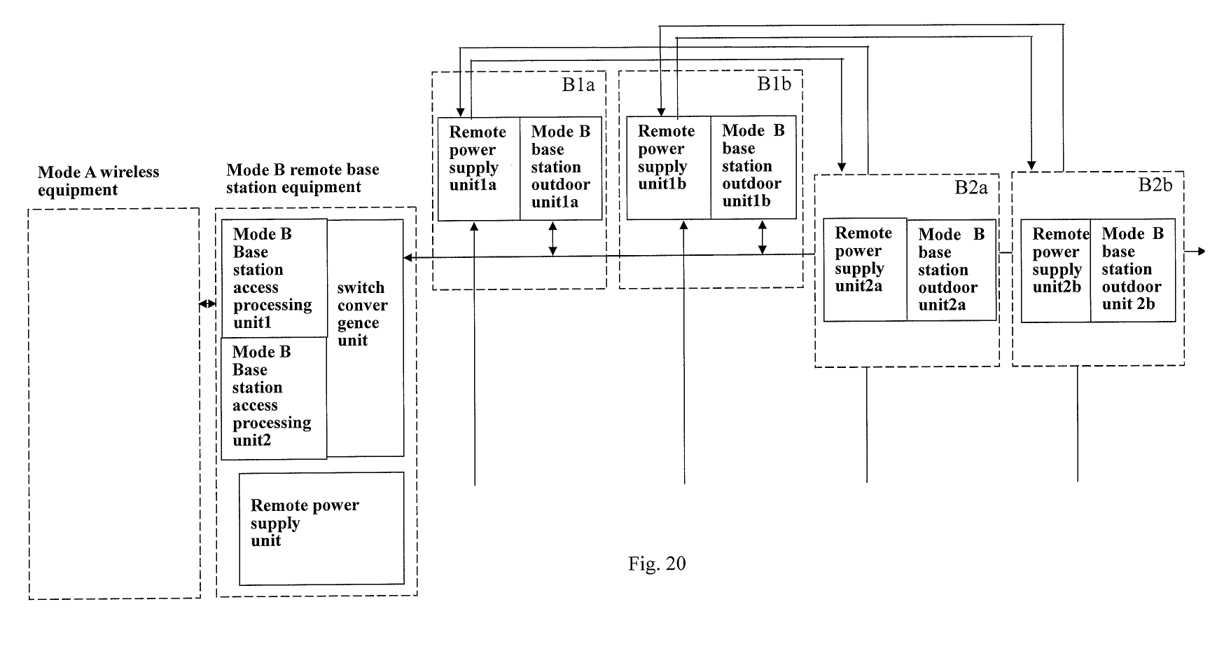

A tenth embodiment is illustrated in FIG. 20.

As shown in FIG. 20, the difference between the system in FIG. 20 and the system in FIG. 18 lies in that the module B base station access processing unit of the module A wireless equipment in FIG. 18 is set in the module B base station remote equipment of FIG. 20 as a part of the base station remote equipment.

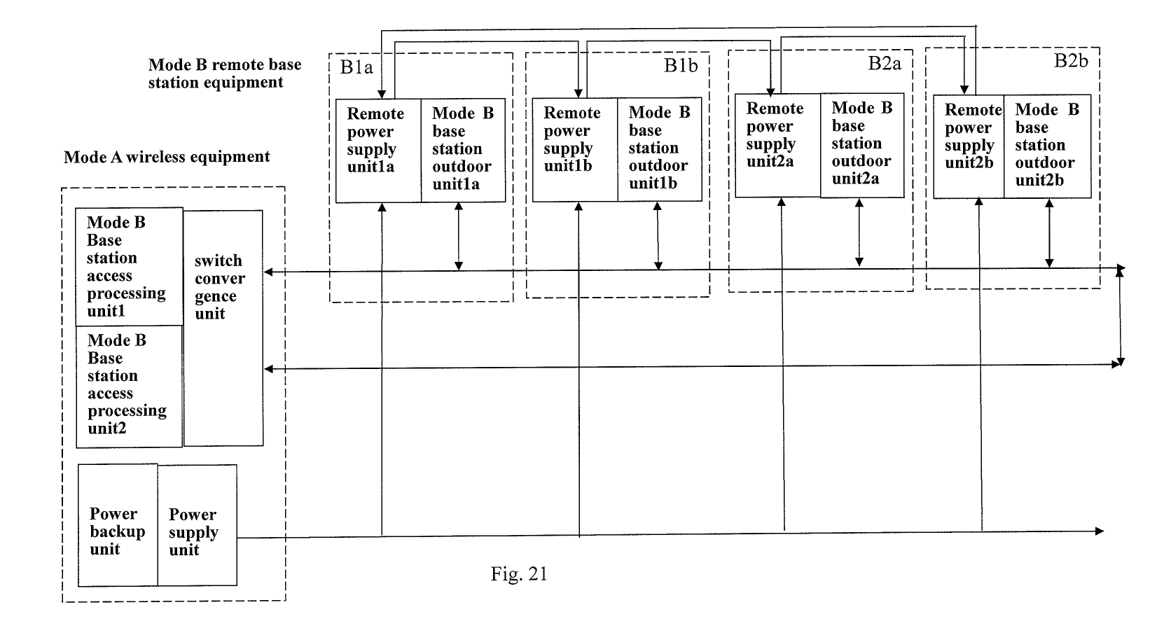

An eleventh embodiment is illustrated in FIG. 21.

As shown in FIG. 21, the difference between the system in FIG. 21 and the system in FIG. 18 lies in that the ring connection is adopted between module A wireless equipment and module B base station remote equipment. For example, a fault occurs in the wireless signal or data cable between module B base station outdoor unit 1a and module A wireless equipment, module B base station outdoor unit 1a may be connected, via the wireless signal or data cable between module A wireless equipment and the module B base station outdoor unit 2b, with module A wireless equipment, so as to improve the reliability of communication.

In FIG. 21, the star, ring or shared bus connection may be adopted between the central power supply unit and module B base station outdoor unit; the star, ring or shared bus connection may be also adopted among the remote power supply units.

The power supply assistance may be implemented among remote power supply units. Multiple module B base station outdoor units may constitute multi-antenna transmit diversity or multi-antenna receive diversity. For example, in FIG. 21, module B base station outdoor units 1a and 1b may constitute bi-antenna transmit diversity or bi-antenna receive diversity; module B base station outdoor units 1a and 2a may also constitute bi-antenna transmit diversity or bi-antenna receive diversity; module B base station outdoor units 1a, 1b, 2a and 2b may constitute qua-antenna transmit diversity or qua-antenna receive diversity.

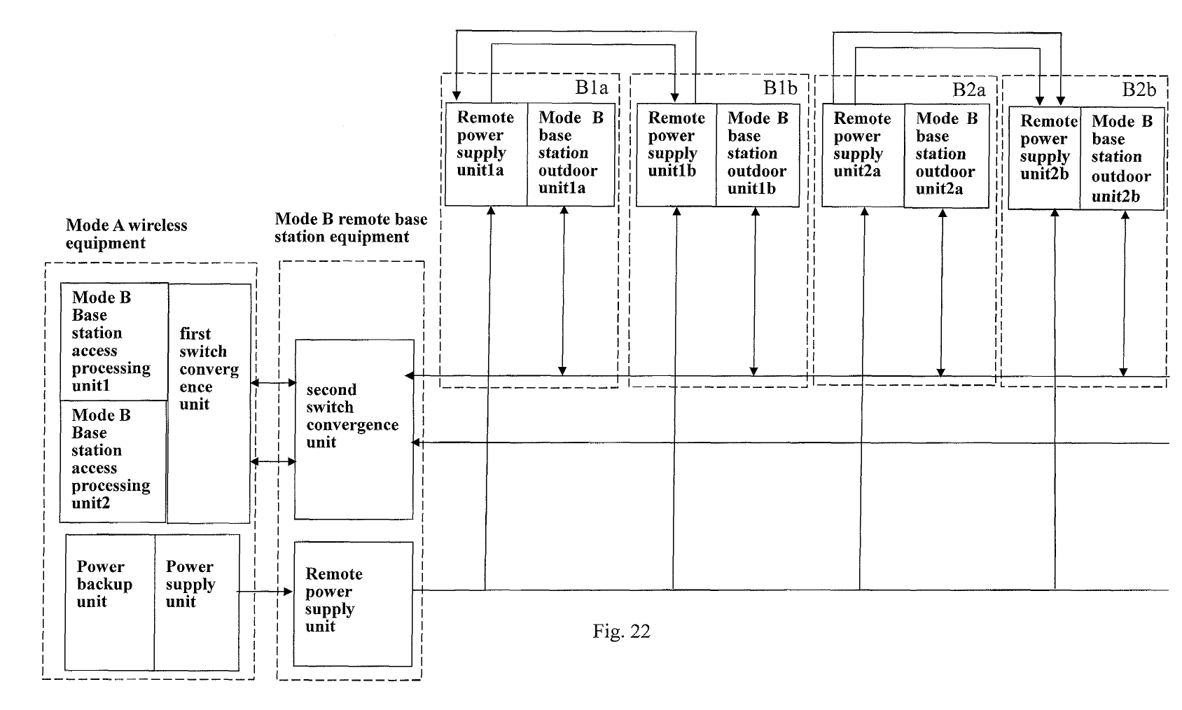

A twelfth embodiment is illustrated in FIG. 22.

As shown in FIG. 22, the difference between the system in FIG. 22 and the system in FIG. 21 lies in that the switch convergence unit of module A wireless equipment in FIG. 21 is set in the module B base station remote equipment of FIG. 22 as a part of the module B base station remote equipment.

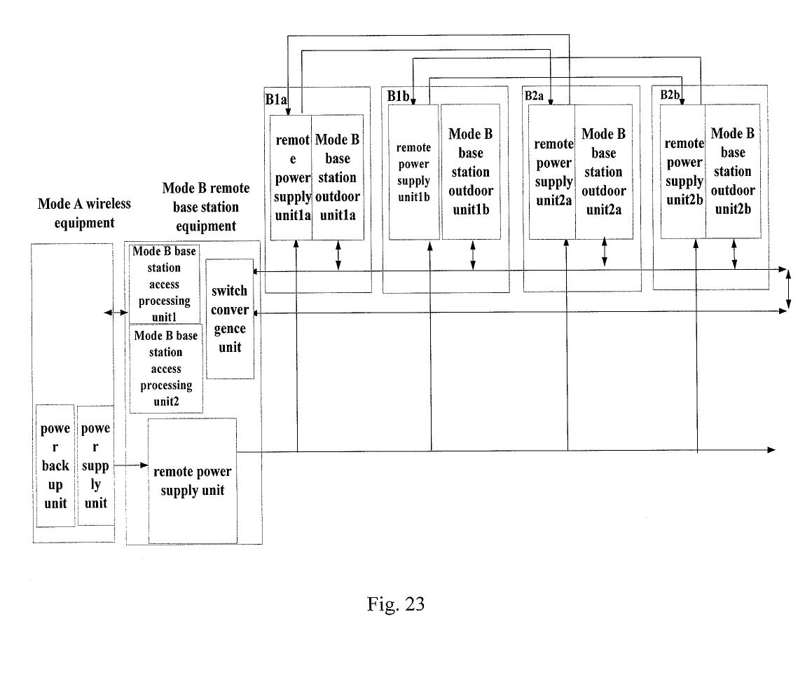

A thirteenth embodiment is illustrated in FIG. 23.

As shown in FIG. 23, the difference between the system in FIG. 23 and the system in FIG. 21 lies in that the module B base station access processing unit of the module A wireless equipment in FIG. 21 is set in the module B base station remote equipment of FIG. 23 as a part of the module B base station remote equipment.

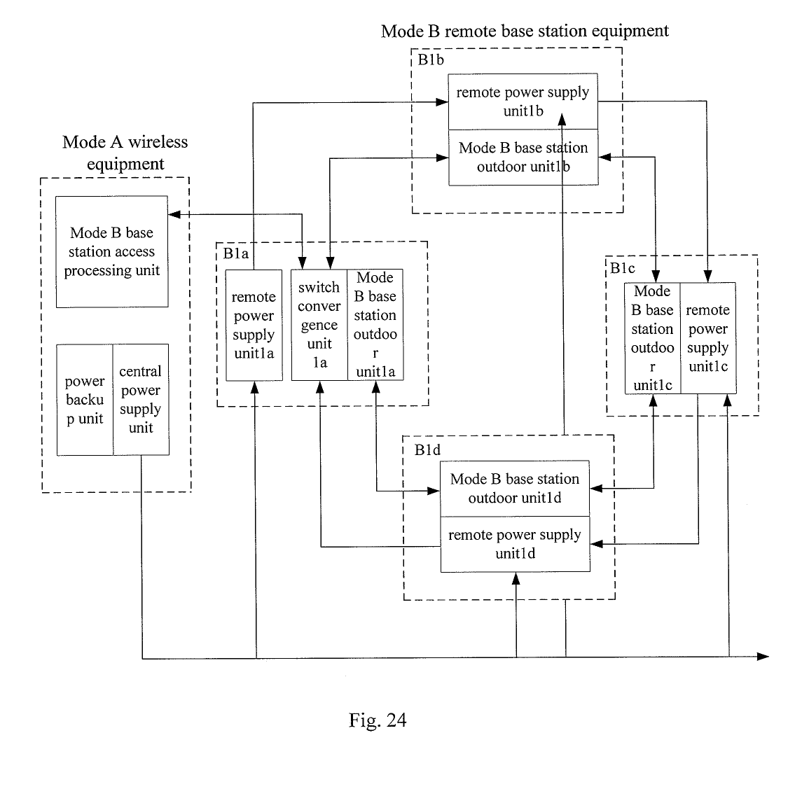

A fourteenth embodiment is illustrated in FIG. 24.

As shown in FIG. 24, the difference between the system in FIG. 24 and the system in FIG. 18 lies in that the net connection is adopted among the module B base station remote equipment of the system in FIG. 24. The module B base station remote equipment B1a and B1b, B1b and B1c, B1c and B1d, B1d and B1a, or B1a and B1c, B1b and B1d may be mutually connected. When there is a failure of wireless signal or data cable occurring between mode B base station outdoor unit 1b and mode B base station remote equipment B1a, mode B base station outdoor unit 1b may connect to the switch convergence unit 1a of the mode B base station remote equipment B1a through mode B base station outdoor unit 1c and/or 1d, connect to mode A wireless equipment through the switch convergence unit 1a of the mode B base station remote equipment B1a.

Star connection, ring connection or shared bus connection may be used to connect central power supply unit with mode B base station outdoor unit or remote power supply unit. Star connection, ring connection or shred bus connection may be applied among remote power supply units.

Remote power supply unit may perform mutual aid in supplying power. Multiple antennas transmit diversity or multiple antennas receive diversity may be constituted among multiple mode B base station outdoor units. For example, in FIG. 24, mode B base station outdoor unit 1a, 1b, 1c and 1d may form quad antennas transmit diversity or quad antennas receive diversity.

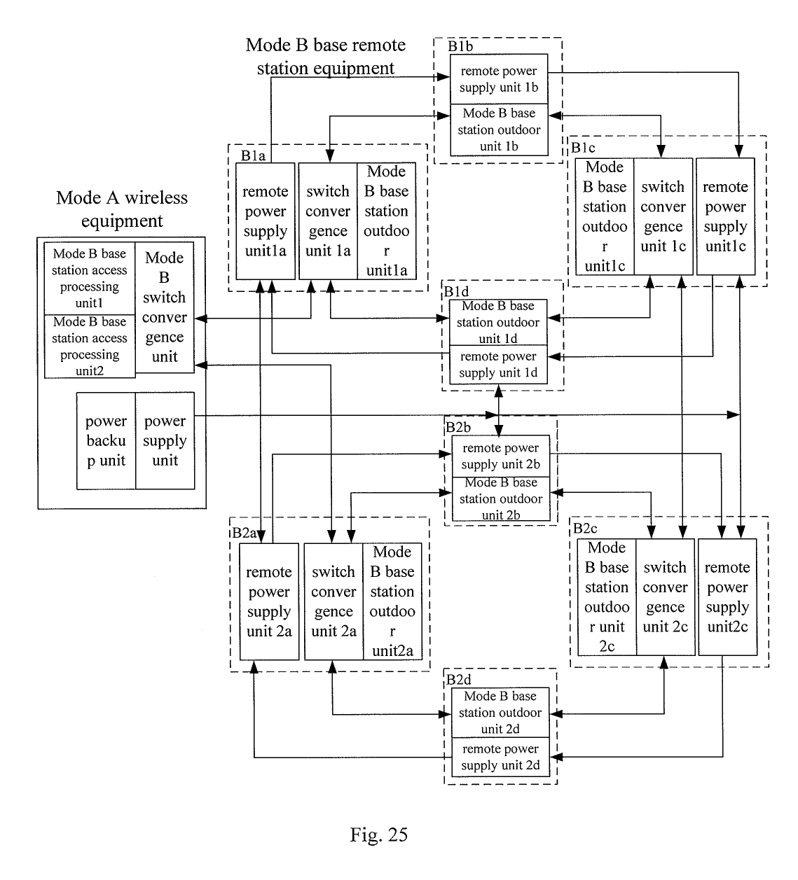

The fifteenth embodiment of the present invention is illustrated in FIG. 25.

The difference between systems illustrated in FIGS. 24 and 25 is that, the system in FIG. 25 includes multiple mode B base station access processing units. Wireless equipment of mode A and mode B base station remote equipment are connected with multiple pairs of signal or data cable as a wet. Through switch convergence unit of mode A wireless equipment, “1+1”, “N+1” backup or backup with redundancy of resource pool may be performed among mode B base station access processing units of mode A wireless equipment and among mode B base station outdoor units. For example, when there is a failure of wireless signal or data cable occurring between mode B base station remote equipment B1a and mode A wireless equipment, mode B base station remote equipment B1a, B1b, B1c and B1d may connect to mode A wireless equipment through mode B base station remote equipment B2c and B2a.

Multiple antennas transmit diversity or multiple antennas receive diversity may be constituted among multiple mode B base station outdoor units. For example, in FIG. 25 multiple mode B base station outdoor unit 1a, 1b, 1c and 1d may form quad antennas transmit diversity or quad antennas receive diversity, multiple mode B base station outdoor unit 2a, 2b, 2c and 2d may form another group of quad antennas transmit diversity or quad antennas receive diversity.

In a word, through technologies of distributed base stations and remote power supply, the present invention solves the conflict in planning multimode wireless network. Therefore operator A may first select site for mode A wireless equipment based on plan for mode A wireless network and construct mode A wireless cellular network, then according to market demand for wireless access, select site for mode B wireless equipment based on plan for mode B wireless network, and through upgrading mode A wireless equipment, add mode B base station access processing unit, convergence unit and remote power supply unit which are in communication with mode B base station outdoor units. Therefore, a complete structure of multimode wireless integrated access equipment is formed and construction of multimode wireless cellular network in a same area is completed, which insures that plans for multimode wireless network are optimal.

Further, mode B base station remote equipment needs no separate AC power supply, battery cell, UPS, electric generator set or mains as backup for power supply, which reduces cost for construction and maintenance for mode B base station.

2. The present invention provides an integrated access distributed system including a first equipment with wired equipment as first mode and a second equipment with wireless equipment as second mode.

The practical structure of the integrated access distributed system including wireless and wired equipment with different modes is similar to that of multimode wireless access distributed system as illustrated in FIG. 11 to FIG. 25. The only difference is that a local device as the second equipment set in a wired equipment in the integrated access distributed system.

3. The present invention also provides a multimode wired integrated access distributed system, which may solve the conflict in selecting sites for original mode A wired equipment and newly added mode B wired equipment caused by difference between different network plans for wired access networks with different modes in the prior art.

In the system of the present invention, newly added wired equipment with new mode is divided into a wired local device and a remote wired device, in which the wired local device is set in the existing wired equipment, i.e. has the same position with the existing wired equipment to utilize existing resource. As for the remote wired device, a best site may be selected based on the network plan with the new mode. Then the remote wired device is set at the best site, which insures good communication effect of the network with the new mode.

In the system of the present invention, the wired local device at least includes a power supplier, and may also include wired access processing unit. Corresponding to the wired local device, the remote wired device is a wired terminal.

The remote wired device may be an IAD with remote power supply, and the wired access processing unit may be an Ethernet switch module.

The remote wired device may be an Ethernet switch with remote power supply, and the wired access processing unit may be a router module.

The remote wired device may be an optical network unit ONU with remote power supply, and the wired access processing unit may be an optical line terminal OLT.

The remote wired device may be a small capacity DSLAM cabinet (digitalized user cable access multiplexer), and the wired access processing unit may be a DSLAM access processing module.

In the present invention, the power supply unit may be central power supply unit, which is used to convert mains input (e.g. 110V/220V AC) or DC input (e.g. −48V/−60V DC) into high voltage DC output (270V DC), and supply power for remote wired terminal via cable line (e.g. twisted pair copper). Distance of remote power supply is related to gauge, number of line pairs, power consumption and output voltage of power supply unit. Generally remote power supply for as far as 2-5 kilometers is available.

The central power supply unit may support the intercommunication with terminals, and as out band management channel of wired terminal, may perform monitoring on normal states and alarm for failures, which facilitates equipment management, failure positioning and remote maintenance.

Additionally, in the present invention, the remote device may include the remote power supply unit, adapted to transform the high voltage DC inputs (e.g. 270V DC) into low voltage DC to supply power locally for the equipment where the remote power supply unit is arranged, or to continually transmit the high voltage DC from the central power supply unit and supply remotely the power for the next level remote base station outdoor units through the wired cable.

The remote power supply unit may support the intercommunication with the wired terminals, and, as out band management channel of wired terminal, may perform monitoring on normal states and alarm for failures, which facilitates equipment management, failure positioning and remote maintenance

The system of the present invention includes a convergence unit that is used to converge access signals received by multiple wired terminals and send to the wired access processing unit; and distribute signals generated by wired access processing unit to multiple wired terminals, further to wired access users.

The convergence unit of the present invention may be set in different equipment.

Being set in wired local device, the convergence unit converges and sends cable signals received by the wired terminal of the remote wired device to the wired access processing unit of the wired local device; and sends signals generated by the wired access processing unit of the wired local device to the wired terminal of the remote wired device.

Being set in remote wired device, the convergence unit is remotely connected to the wired access processing unit of the wired local device and remotely connected to the wired terminal of the remote wired device via cable lines, and is used to converge wired access signals received by multiple wired terminals of remote wired device and send to the wired access processing unit of the wired local device, and send signals generated by wired access processing unit of the wired local device to the wired terminal of the remote wired device.

Being set in remote wired device, the convergence unit is connected to the wired access processing unit of the remote wired device and remotely connected to the wired terminal of the remote wired device via cable lines, and is used to converge wired access signals received by multiple wired terminals of remote wired device and send to the wired access processing unit of the remote wired device, and send signals generated by wired access processing unit of the remote wired device to the wired terminal of the remote wired device.

In the system of the present invention, when there are multiple wired access processing units, each of them is in communication with the wired terminal via the switch convergence unit. Backup is implemented among the multiple wired access processing units based on the switch convergence unit.

Being set in the remote wired device or wired local device, the switch convergence unit converges cable signals received by the wired terminal of the remote wired device, and then selectively accesses to one of the wired access processing units of the remote wired device or wired local device; and sends signals generated by one of the wired access processing units of the remote wired device or wired local device to the wired terminal of the remote wired device.

Further more, the switch convergence unit may be set in the remote wired device and wired local device respectively, a first switch convergence unit set in the wired local device is remotely connected to a second switch convergence unit set in the remote wired unit, and the second switch convergence unit is also remotely connected to the wired terminal. The second switch convergence unit is used to converge and then send wired access signals received by multiple wired terminals of remote wired devices to the first switch convergence unit. Then the first switch convergence unit selectively accesses the signals to one of the wired access processing units of the wired local device, and sends signals generated by each wired access processing unit of the wired local device to the second switch convergence unit. The second switch convergence unit selectively accesses the signals to one of the wired terminals of the remote wired device.

Embodiments will be given to describe the system of the present invention.

It is assumed in the following description that mode A wired access network is a basic network, mode B wired access network is a newly added network, mode A wired access equipment set in the basic network serves as a local communication equipment.

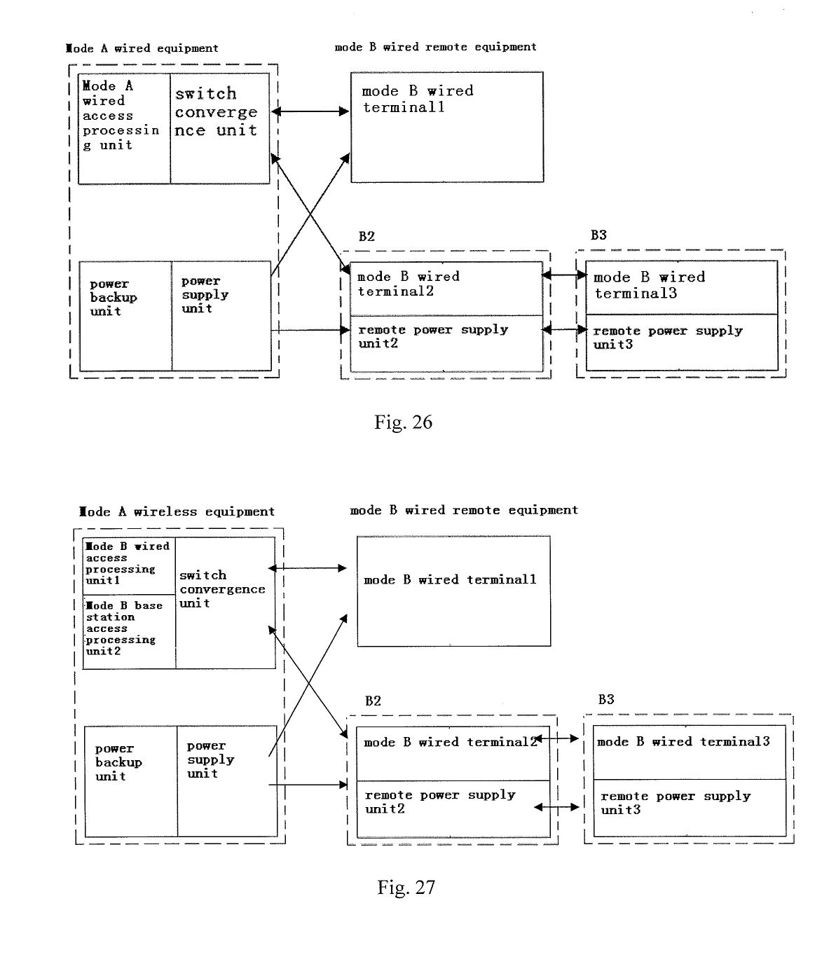

The first embodiment of the present invention is as illustrated in FIG. 26, including mode A wired local equipment, mode B wired remote equipment, convergence unit, mode B wired access processing unit, central power supply unit, remote power supply unit and power backup unit. Local equipment includes some existing equipment of the mode A wired access network. The mode B wired remote equipment includes a mode B wired terminal or an integrated equipment combining mode B wired terminal with remote power supply unit.

In the present invention, the mode B wired access processing unit and the convergence unit are set in the mode A wired local equipment that selects optimal site based on plan for mode A wired network. The mode B wired terminal is set as remote device and selects optimal site based on plan for mode B wired network.

The mode B wired terminal equipment is remotely connected to mode A wired local equipment in a star connection via cable lines (e.g. fiber or twisted pair copper). When there are multiple mode B wired terminals, each of them may be remotely connected to each other via cable lines. For example, in FIG. 26 mode B wired terminals 2 and 3 are remotely connected to each other via cable line.

The central power supply unit set in the mode A wired equipment supplies power for mode B wired access processing unit 1 and mode B wired remote terminal 1.

The remote power supply unit 2 in the mode B wired remote equipment is remotely connected to the central power supply unit via cable line and supplies power for the mode B wired terminal 2. The remote power supply unit 2 in the mode B wired remote equipment is further remotely connected to remote power supply unit 3 in next level via cable line and supplies power for mode B wired terminal 3 in next level.

The remote power supply unit is logically separate from the mode B wired terminal, but may be separate from or integrated with the mode B wired terminal physically.

In the drawing, there are cable lines between the mode A wired local equipment and mode B wired remote equipment for remote connection. Signal cable between the mode A wired local equipment and mode B wired remote equipment is separate from power cable, but may be separate from or integrated with the power cable physically. When the signal cable and the power cable are integrated a same cable line may be adopted.

Star connection, ring connection or shared bus connection may be adopted between the central power supply unit and the mode B wired terminal or among the remote power supply units. FIG. 26 illustrates a star connection. A star connection, ring connection or shared bus connection also may be adopted among remote power supply units.

The mode B wired terminal and the mode B wired access processing unit perform wired access processing. When multiple mode B wired terminals are involved the convergence unit is needed to achieve communication with the mode B wired access processing unit, that is the convergence unit converges cable access signals received by multiple mode B wired terminals and then sends to the mode B wired access processing unit, and distributes signals generated by the mode B wired access processing unit to multiple mode B wired terminals, further to mode B wired access users.

The central power supply unit converts mains input (e.g. 110V/220V AC) or DC input (e.g. −48V/−60V DC) into high voltage DC output (270V DC), and supply power for the mode B wired remote terminal via cable line (e.g. twisted pair copper). Distance of remote power supply is related to gauge, number of line pairs, power consumption of the mode B wired terminal and output voltage of power supply unit. Generally remote power supply for as far as 2-5 kilometers is available.

The central power supply unit may support communication with the mode B wired terminals, and as the out band management channel of the mode B wired terminal may perform monitoring on normal states and alarm for failures, which facilitate equipment management, failure positioning and remote maintenance. The power backup unit may be battery cell, UPS, electric generator set or mains. In order to guarantee the power supply, the central power supply unit needs to be configured with the power supply unit to backup power. The power backup unit may be a battery pack, a UPS, a power generation set, or a second mains power.

The second embodiment of the present invention is illustrated in FIG. 27.

The difference between systems illustrated in FIG. 27 and FIG. 26 is that the convergence unit in FIG. 26 is substituted by the switch convergence unit in FIG. 27, the mode B wired access processing unit is added into the mode A wired local equipment. Through the switch convergence unit, “1+1”, “N+1” backup or backup with redundancy of resource pool may be performed among the mode B wired access processing units of mode A wired equipment and among the mode B wired terminals.

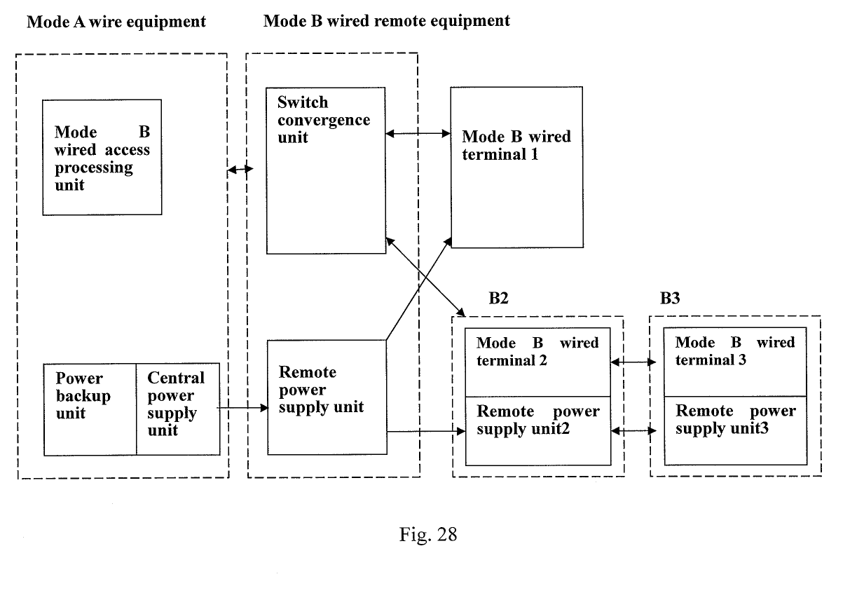

The third embodiment of the present invention is illustrated in FIG. 28.

The difference between systems illustrated in FIG. 28 and FIG. 26 is that the convergence unit of the mode A wired local equipment in FIG. 26 is set in the mode B wired terminal in FIG. 28. The mode B wired remote equipment includes convergence unit and remote power unit. For example, the convergence unit and the remote power unit may be a simple switch with remote power supply through which cable lines between mode A wired equipment and mode B wired terminal may be saved.

In FIG. 28, the mode A wired equipment selects optimal site based on plan for mode A wired network, and the mode B wired equipment selects optimal site based on plan for mode B wired network. The mode B wired terminals are converged by the mode B wired remote equipment, and are remotely connected to the mode A wired equipment via cable lines. The central power supply unit of the mode A wired equipment remotely supplies power with DC (2-5 kilometers) for the mode B wired terminal. The remote power supply unit of the mode B wired terminal supplies power with DC (e.g. 100-200 meters) for mode B wired terminal or the integrated equipment combining mode B wired terminal with remote power supply unit.

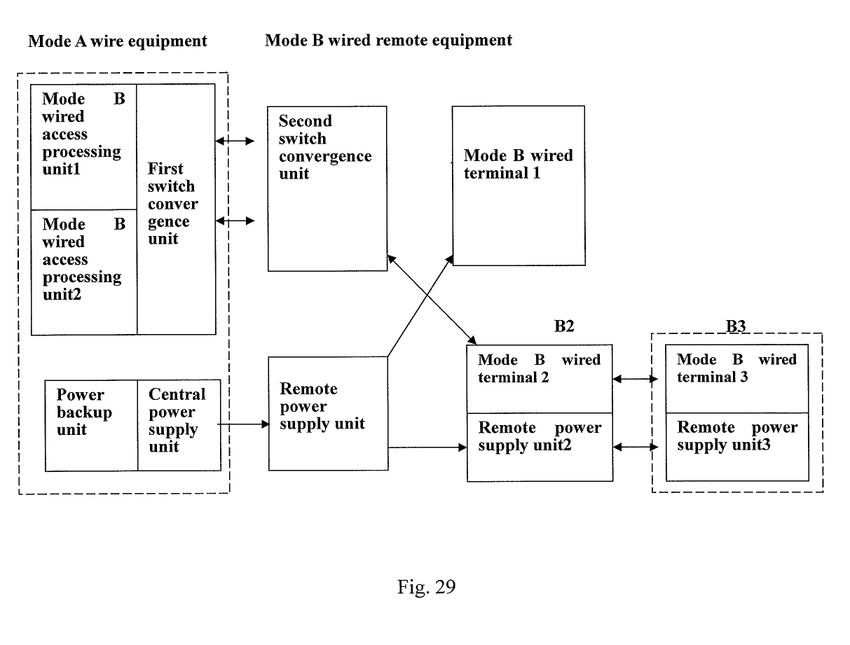

The fourth embodiment of the present invention is illustrated in FIG. 29.

The difference between the systems illustrated in FIG. 29 and FIG. 28 is that the convergence unit in FIG. 28 is substituted by the switch convergence unit in FIG. 29, the mode A wired local equipment is connected to the mode B wired terminal via pairs of signal cable or data cable. Through the switch convergence unit, “1+1”, “N+1” backup or backup with redundancy of resource pool may be performed among the mode B wired access processing units of mode A wired equipment, among the mode B wired terminals and for the signal cable or data cable between the mode A wired equipment and the mode B wired terminal.

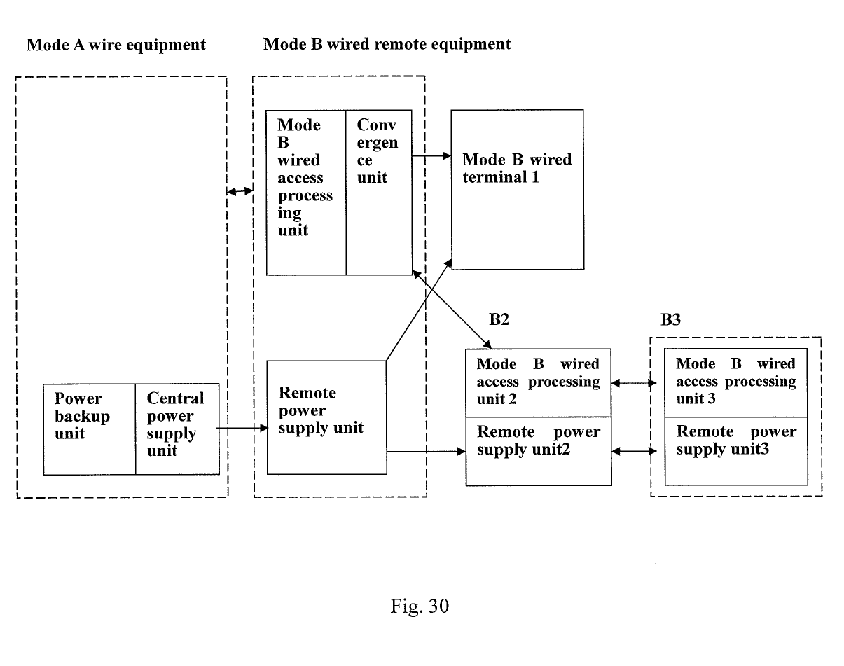

The fifth embodiment of the present invention is illustrated in FIG. 30.

The difference between systems illustrated in FIG. 30 and FIG. 28 is that the mode B wired access processing unit of mode A wired equipment is also set in the mode B wired terminal in FIG. 30. The mode B wired remote equipment is composed of mode B wired access processing unit, switch convergence unit and remote power supply unit, i.e. only an existing power supply unit in the existing mode A wired equipment is utilized.

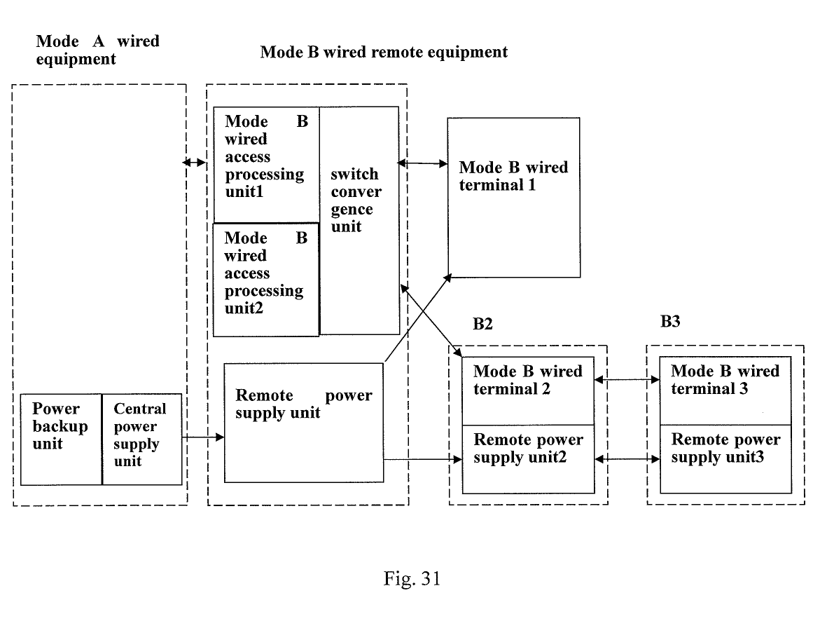

The sixth embodiment of the present invention is illustrated in FIG. 31.

The difference between systems illustrated in FIG. 31 and FIG. 30 is that the convergence unit in FIG. 30 is substituted by the switch convergence unit in FIG. 31, the mode A wired local equipment is connected to the mode B wired terminal via pairs of signal cable or data cable. Through the switch convergence unit, “1+1”, “N+1” backup or backup with redundancy of resource pool may be performed among the mode B wired access processing units and among the mode B wired terminals, thus reliability of communication is improved.

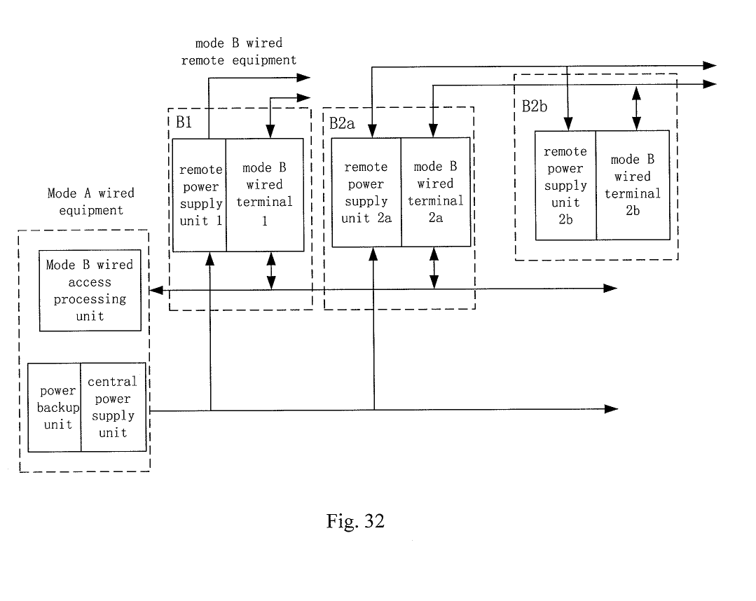

The seventh embodiment of the present invention is illustrated in FIG. 32.

The difference between systems illustrated in FIG. 32 and FIG. 26 is that the in the system of FIG. 32, the mode A wired local equipment and the mode B wired terminal is remotely connected in tree structure. For example, in FIG. 32, mode B wired terminals 1 and 2a share a cable line in a frequency division multiplexing or time division multiplexing mode to remotely connect to the mode A wired equipment, and the mode B wired terminal 2b is a branch of the mode B wired terminal 2a.

In FIG. 32, there are cable lines set between the mode A wired local equipment and mode B wired remote equipment, and the signal cable and power cable between the mode A wired local equipment and mode B wired remote equipment are logically separate, bur may be separate or integrated physically.

In FIG. 32, a star connection, ring connection or shared bus connection may be adopted between the central power supply unit and the mode B wired terminal or the remote power supply unit. A star connection, ring connection or shared bus connection also may be adopted among remote power supply units.

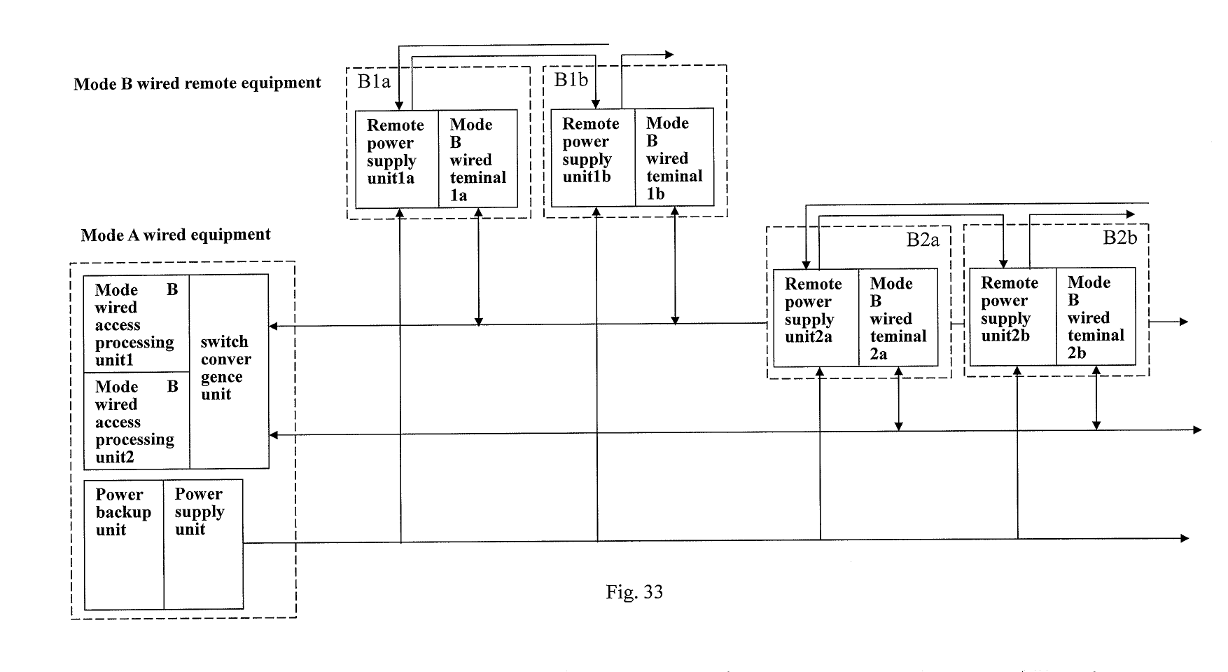

The eighth embodiment of the present invention is illustrated in FIG. 33.

The difference between systems illustrated in FIG. 33 and FIG. 32 is that multiple mode B wired acceded processing units are added into the system in FIG. 33, and the mode A wired local equipment is in tree connection with the mode B wired terminal via pairs of signal cable or data cable. Through the switch convergence unit, “1+1”, “N+1” backup or backup with redundancy of resource pool may be performed among the mode B wired access processing units of the mode A wired equipment and among the mode B wired terminals.

A star connection, ring connection or shared bus connection may be adopted between the central power supply unit and the mode B wired terminal or the remote power supply unit. A star connection, ring connection or shared bus connection also may be adopted among remote power supply units.

As illustrated in FIG. 33, at a same branch or at different branches, power supplying assistance may be performed among remote power supply units. For example, at the same branch in FIG. 33, remote power supply units 1a and 1b perform power supplying assistance between each other. When there is a connection failure of cable line between the central power supply unit and the remote power supply unit 1a, the remote power supply unit 1a may remotely supply power through the remote power supply unit 1b. When there is a connection failure of cable line between the central power supply unit and the remote power supply unit 1b, the remote power supply unit 1b may remotely supply power through the remote power supply unit 1a.

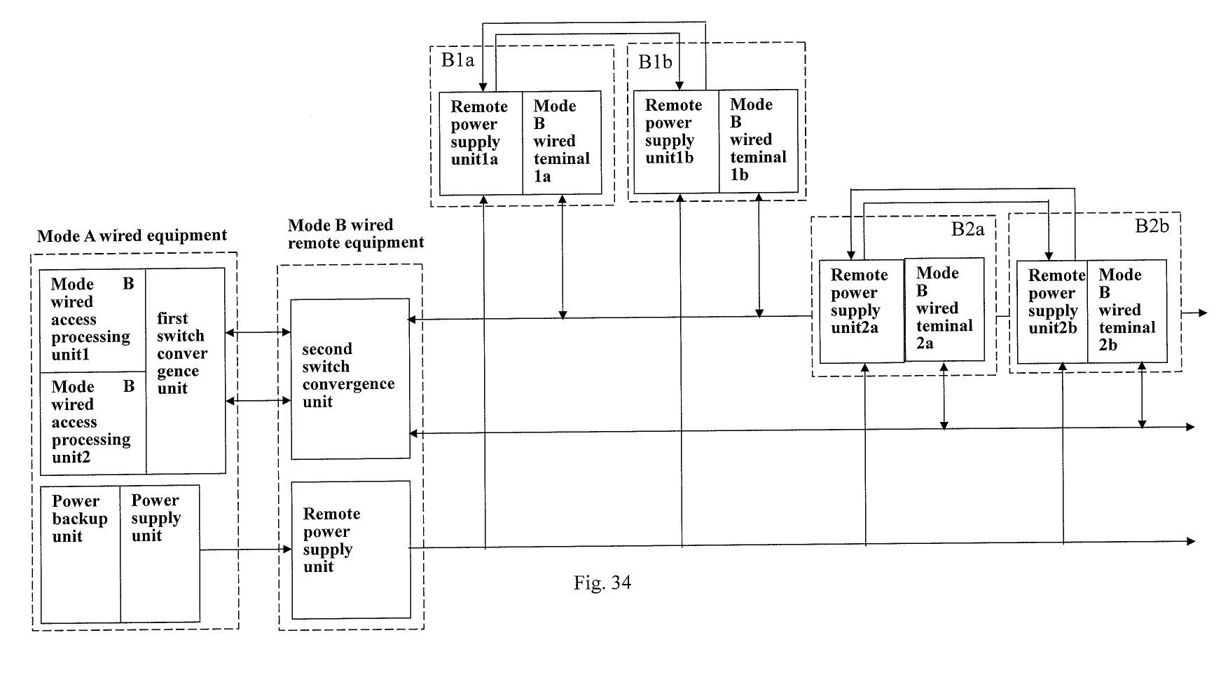

The ninth embodiment of the present invention is illustrated in FIG. 34.

The difference between systems illustrated in FIG. 34 and FIG. 33 is that the switch convergence unit of the mode A wired equipment in FIG. 33 is also set in the mode B wired remote equipment in FIG. 34 as a part of the remote wired equipment. Therefore, a switch convergence function is realized, cable lines between the mode B wired terminal and the mode A wired equipment are simplified and saved.

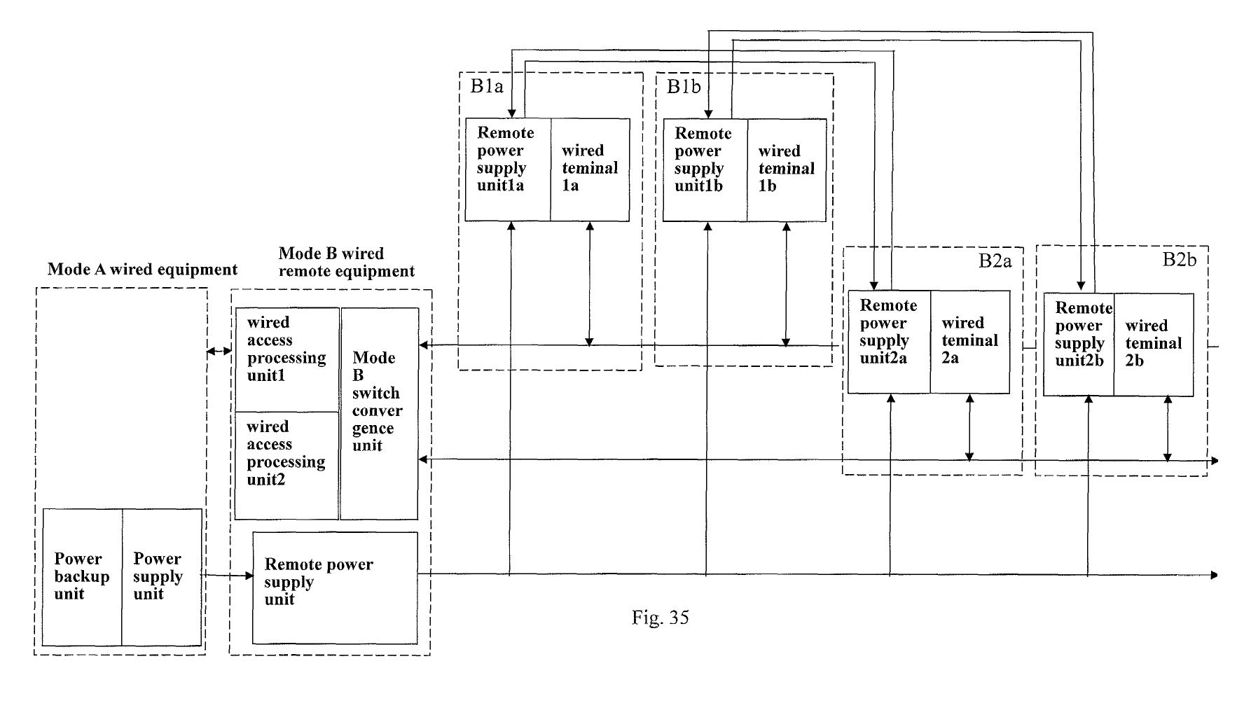

The tenth embodiment of the present invention is illustrated in FIG. 35.

The difference between systems illustrated in FIG. 35 and FIG. 33 is that the mode B wired access processing unit of the mode A wired equipment in the system of FIG. 33 is also set in the mode B wired remote equipment in FIG. 35, that is the mode B wired equipment and the mode A wired equipment only share the power supply unit and the power backup unit.

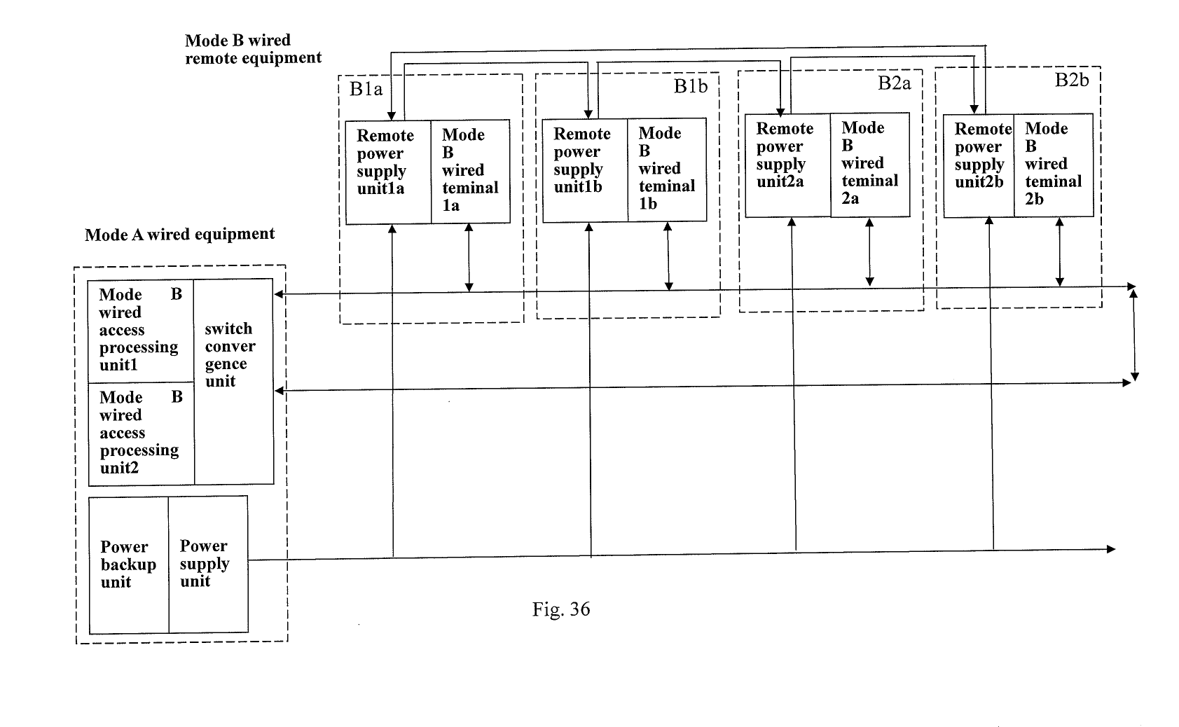

The eleventh embodiment of the present invention is illustrated in FIG. 36.

The difference between systems illustrated in FIG. 36 and FIG. 33 is that the mode A wired local equipment in the system of FIG. 36 is in ring connection with the mode B wired terminal. For example, when there is a failure of cable signal or data cable lines occurring between the mode B wired terminal 1a and the mode A wired equipment, the mode B wired terminal 1a may connect to the mode A wired equipment via the cable signal or data cable lines between the mode B wired terminal 2b and the mode A wire equipment.

Similarly, a star connection, ring connection or shared bus connection may be adopted between the central power supply unit and the mode B wired terminal or the remote power supply unit. A star connection, ring connection or shared bus connection also may be adopted between remote power supply units.

Power supplying assistance may be performed among the remote power supply units. When there is a remote power supply unit of the mode B wired terminal breakdown, switching to another normal remote power supply unit may be performed. Then the remote power supply unit in working order will supply power for the mode B wired terminal.

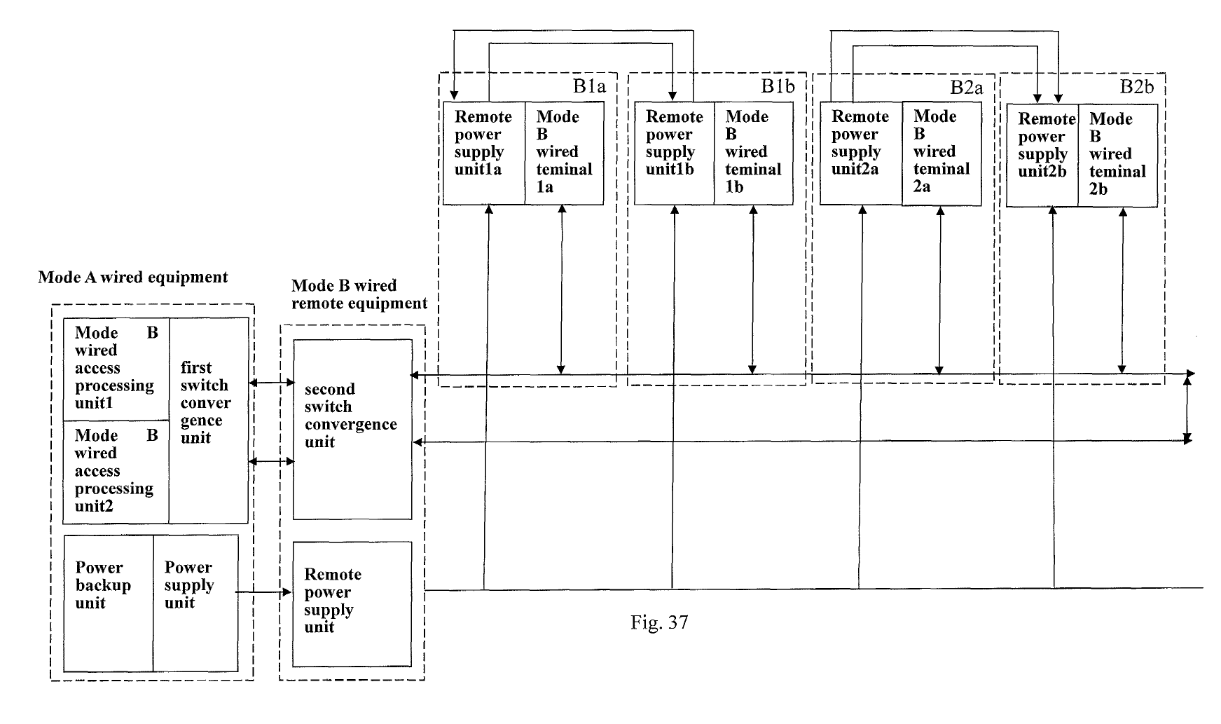

The twelfth embodiment of the present invention is illustrated in FIG. 37.

The difference between systems illustrated in FIG. 37 and FIG. 36 is that he switch convergence unit of the mode A wired local equipment in the system of FIG. 36 is also set in the mode B wired terminal in FIG. 37, that is the mode A wired equipment is in communication with the mode B wired remote equipment via a first switch convergence unit and a second switch convergence unit.

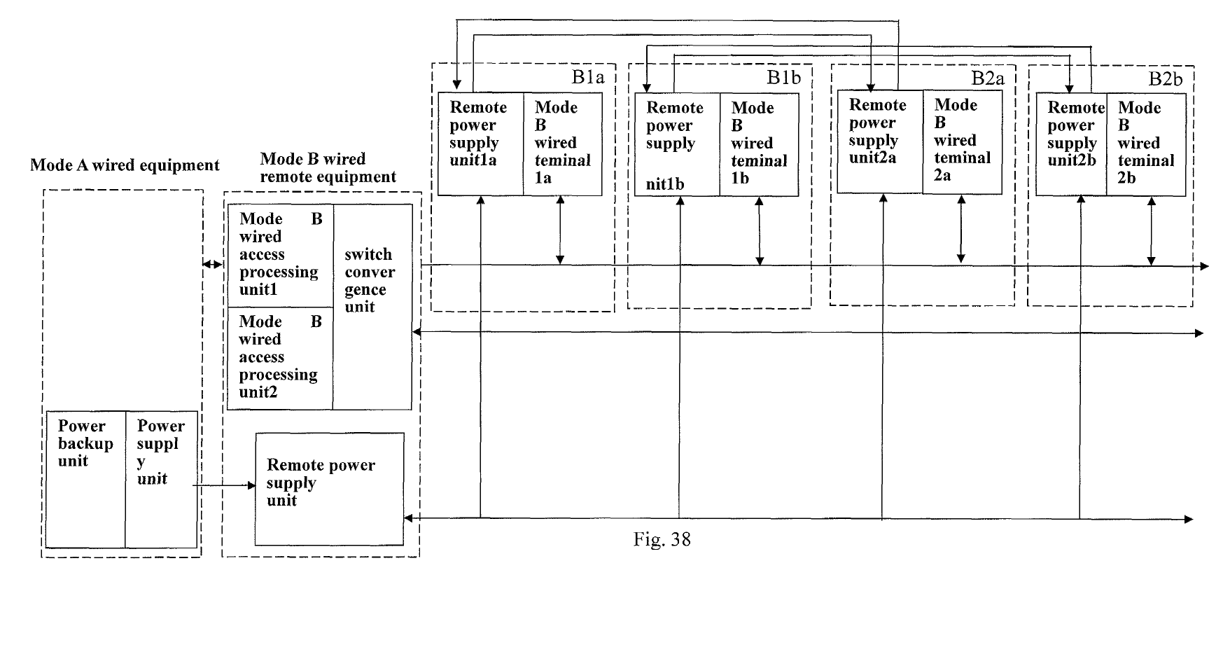

The thirteenth embodiment of the present invention is illustrated in FIG. 38.

The difference between systems illustrated in FIG. 38 and FIG. 36 is that the mode B wired access processing unit of the mode A wired equipment in the system of FIG. 36 is also set in the mode B wired remote equipment in FIG. 38, that is the mode B wired equipment and the mode A wired equipment only share the power supply unit and the power backup unit of the mode A wired equipment.

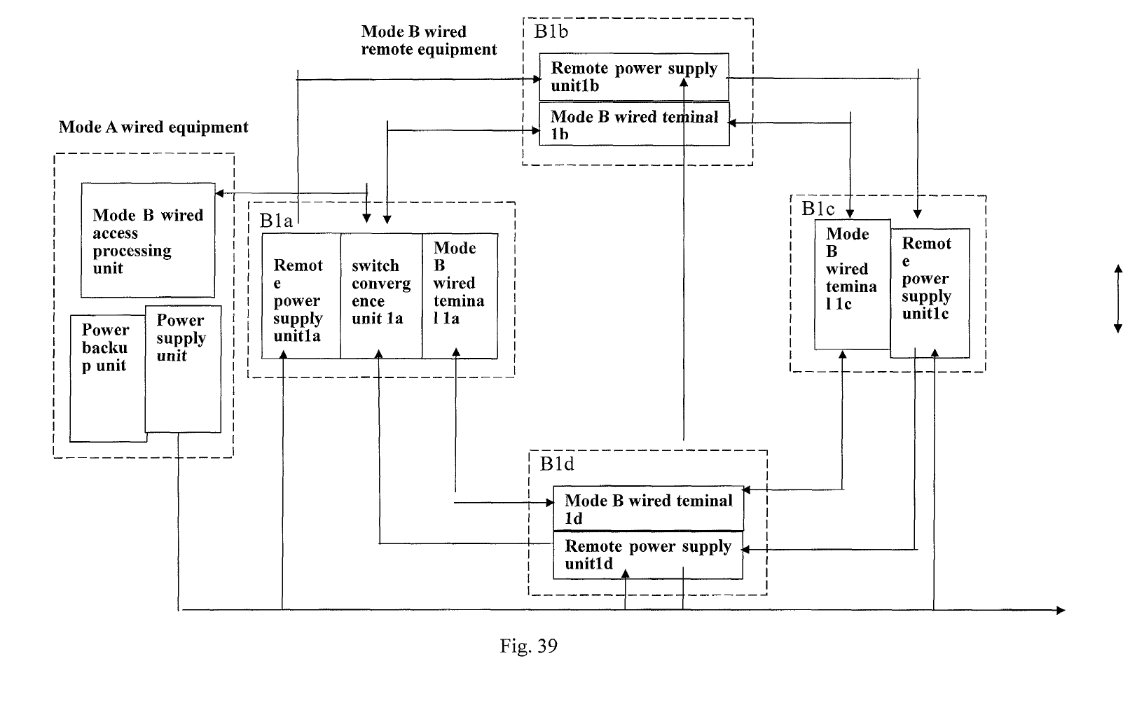

The fourteenth embodiment of the present invention is illustrated in FIG. 39.

The difference between systems illustrated in FIG. 39 and FIG. 33 is that the mode B wired terminals in the system of FIG. 39 are in net connection. For example, the mode B wire terminals B1a and B1b may be connected to each other, as well as B1c and B1d, B1b and B1c, B1d and B1a, B1a and B1c, B1b and B1d. When there is a failure of cable signal or data cable lines occurring between the mode B wired terminal 1b and the mode B wired terminal B1a, the mode B wire terminal 1b may connect to the switch convergence unit 1a of the mode B wired terminal B1a through the mode B wired terminal 1c and/or 1d, and then connect to the wired equipment though the switch convergence unit 1a of the mode B wired terminal B1a.

In FIG. 39, a star connection, ring connection or shared bus connection may be used to connect central power supply unit with mode B wired terminal or remote power supply unit. A star connection, ring connection or shred bus connection may be applied to remote power supply units.

Further, power supplying assistance may be performed among the remote power supply units, which improves reliability of power supply unit.

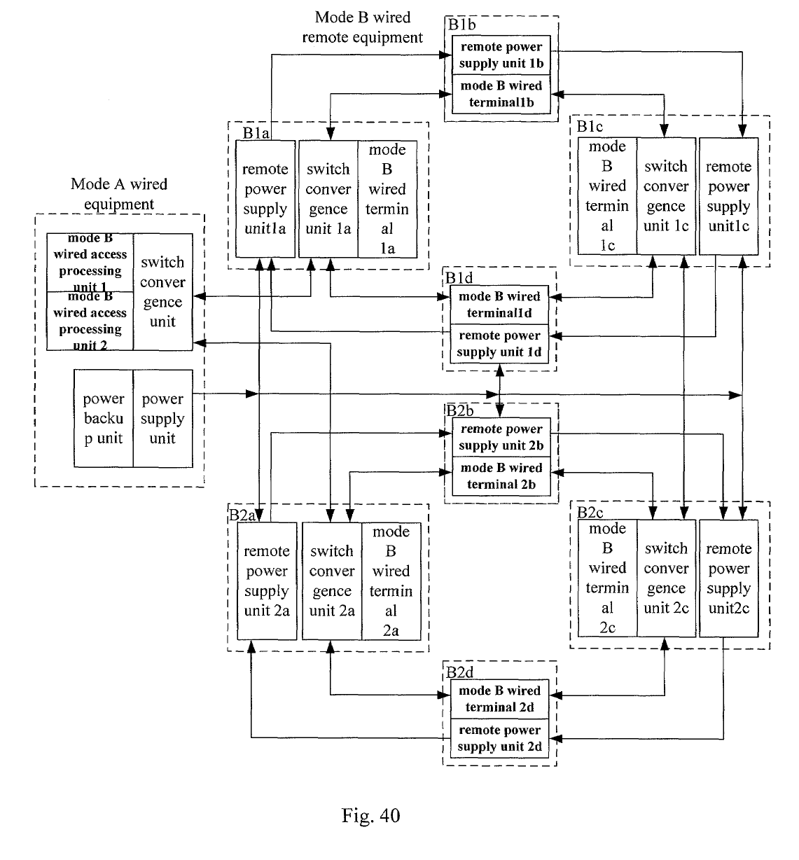

The fifteenth embodiment of the present invention is illustrated in FIG. 40.

The difference between systems illustrated in FIG. 40 and FIG. 39 is that multiple mode B wired access processing units are added into the system in FIG. 40, and the mode A wired local equipment is in net connection with the mode B wired terminal via pairs of signal cable or data cable. Through the switch convergence unit of the mode A wired equipment, “1+1”, “N+1” backup or backup with redundancy of resource pool may be performed among the mode B wired access processing units of the mode A wired equipment and among the mode B wired terminals. For example, when there is a failure of cable signal or data cable line between the mode B wired terminal B1a and the mode A wired equipment, the mode B wired terminals B1a, B1b, B1c and B1d may connect to the mode A wired equipment through the mode B wired terminals B2c and B2a.

In conclusion, the present invention solves the conflict in plans for mode A wired network and mode B wired network through technologies of distributed equipment and remote power supply.

In the present invention, operator B may first select site for mode A wired equipment based on plan for mode A wired network and construct wire access network, then according to market demand for wired access, select site for mode B wired terminal based on plan for mode B wired network, and through upgrading mode A wired equipment to add a wired access processing unit, convergence unit and remote power supply unit which are in communication with the mode B wired terminals. Therefore, a complete structure of multimode wired integrated access equipment is formed and construction of multimode wired access network in a same area is completed, which insures that plans for multimode wireless network are optimal.

Further, setting the mode B wired remote equipment needs no separate AC power supply, battery cell, UPS, electric generator set or mains as backup for power supply, which effectively reduces cost for construction and maintenance for mode B wired network.

4. The present invention provides an integrated access distributed system in which a wireless equipment serves as the first equipment with a first mode and a wired equipment serves as second equipment with a second mode.

The practical structure of the integrated access distributed system including wireless and wired equipment with different modes is similar to that of the multimode wireless access distributed system as illustrated in FIG. 26 to FIG. 40. The only difference is that a wired local device as the second equipment set in the wired equipment i.e. the mode A wired equipment, is set as the second equipment in a wireless equipment i.e. the base station, in the integrated access distributed system.

Additional advantages and modifications may be readily recognized by a person of ordinary skill in the art. Therefore, the invention in its broader aspects is not limited to the specific details and representative embodiments shown and described herein. Accordingly, various modifications and variations may be made without departing from the spirit or scope of the invention as defined by the appended claims and their equivalents.

What is claimed is:

1. A multimode network communication system, comprising first equipment based on a first mode and second equipment based on a second mode, wherein the second equipment comprises a local device and a remote device, the local device being arranged in the first equipment and the remote device being independent of the first equipment.

2. The multimode network communication system according to claim 1, wherein the remote device is remotely connected with the local device via wired cables.

3. The multimode network communication system according to claim 1, wherein:
in the situation that the second equipment is wireless equipment, the local device comprises a power supply unit and a base station access processing unit, and the remote device comprises a base station outdoor unit; or the local device comprises the power supply unit and the remote device comprises the base station outdoor unit and the base station access processing unit; and
in the situation that the second equipment is wired equipment, the local device comprises the power supply unit and a wired access processing unit and the remote device comprises a wired terminal; or the local device comprises the power supply unit and the remote device comprises the wired terminal and the wired access processing unit.

4. The multimode network communication system according to claim 3, wherein the power supply unit comprises a central power supply unit and a power backup unit.

5. The multimode network communication system according to claim 3, wherein the remote device further comprises a remote power supply unit; and
the remote power supply unit is connected with the power supply unit arranged in the local device via the wired cables, and acquires electric energy to supply power for the remote device; or,
the remote power supply unit acquires local electric energy, and is connected with the base station outdoor unit or wired terminal arranged in the remote device via the wired cables, to supply power for the base station outdoor unit or wired terminal; or,
the remote power supply unit is connected with a remote power supply unit of a next level remote device via the wired cables, to supply power for the next level remote device.

6. The multimode network communication system according to claim 4, wherein
the central power supply unit is arranged in the first equipment to supply power for the first equipment, connected with the remote device via the wired cables to supply power for the remote device, and/or connected with the base station outdoor unit or wired terminal via the wired cables to supply power for the base station outdoor unit or wired terminal;
the power backup unit is arranged in the first equipment to be the backup power supply for the central power supply unit.

7. The multimode network communication system according to claim 3, wherein
the local device and (or) the remote device further comprises a convergence unit, wherein the convergence unit is arranged in the local device, adapted to converge and then access signals received by the base station outdoor unit or wired terminal arranged in the remote device to the base station access processing unit or wired access processing unit arranged in the local device, and to send signal generated by the base station access processing unit or wired access processing unit arranged in the local device to the base station outdoor unit or wired terminal arranged in the remote device; or,
the convergence unit is arranged in the remote device and remotely connected with the base station access processing unit or wired access processing unit arranged in the local device via wired cables and remotely connected with the base station outdoor unit or wired terminal arranged in the remote device, adapted to converge and transmit signals received by the base station outdoor unit or wired terminal arranged in multiple remote devices to the base station access processing unit or wired access processing unit arranged in the local device, and to send signal generated by the base station access processing unit or wired access processing unit arranged in the local device to the base station outdoor unit or wired terminal arranged in the remote device; or,
the convergence unit is arranged in the remote device and connected with the base station access processing unit or wired access processing unit arranged in the remote device via wired cables and remotely connected with the base station outdoor unit or wired terminal arranged in the remote device, adapted to converge and then transmit signals received by the base station outdoor unit or wired terminal arranged in multiple remote devices to the base station access processing unit or wired access processing unit arranged in the remote device, and to send signal generated by the base station access processing unit or wired access processing unit arranged in the remote device to the base station outdoor unit or wired terminal arranged in the remote device.

8. The multimode network communication system according to claim 3, wherein,
if the second equipment is wireless equipment,
the base station access processing unit comprises: a wireless data upper link layer processing module and at least one of a wireless data link layer processing module, a base band processing module, an intermediate-frequency processing module and radio frequency post processing module; and
the base station outdoor unit comprises: an antenna and an radio frequency pre processing module, and at least one of the radio frequency post processing module, the intermediate frequency processing module, the base band processing module and the wireless data link layer processing module.

9. The multimode network communication system according to claim 3, wherein in the situation that the second equipment is wired equipment,
the wired terminal is an Integrated Access Equipment, IAD, with remote power supply, and the wired access processing unit is an Ethernet switch module; or,
the wired terminal is an Ethernet switch with remote power supply, and the wired access processing unit is a router module; or,
the wired terminal is an Optical Network Unit, ONU, with remote power supply, and the wired access processing unit is an Optical Line Terminal, OLT; or,
the wired terminal is a Digital Subscriber Line Access Multiplexer, DSLAM, cabinet with remote power supply, and the wired access processing unit is a DSLAM access processing module.

10. The multimode network communication system according to claim 3, wherein, in the situation that there are multiple base station access processing units or wired access processing units, each of the base station access processing units or wired access processing units communicates, via a switch convergence unit, with the base station outdoor unit or the wired terminal; and the base station access processing unit or wired access processing unit provides backup for each other on the base of the switch convergence unit.

11. The multimode network communication system according to claim 10, wherein:
the switch convergence unit is arranged in the local device or remote device, adapted to converge and then selectively access signals received by the base station outdoor unit or wired terminal arranged in the remote device to a base station access processing unit or wired access processing unit arranged in the local device or remote device, and to send signal generated by the base station access processing unit or wired access processing unit arranged in the local device or remote device to the base station outdoor unit or wired terminal arranged in the remote device; or,
two switch convergence units are respectively arranged in the local device and remote device, a first switch convergence unit arranged in the local device is remotely connected with a second switch convergence unit arranged in the remote device, and the second switch convergence unit is also remotely connected with the base station outdoor unit or the wired terminal, wherein, the second switch convergence unit is adapted to send signals received by the multiple base station outdoor units or wired terminals arranged in the remote devices to the first switch convergence unit which selectively accesses the signals to one of the base station outdoor units or wired access processing units arranged in the local device; the first switch convergence unit is adapted to send signals generated by each of the base station access processing unit or wired access processing unit arranged in the local device to the second switch convergence unit which selectively accesses the signals to the one of the base station outdoor units or wired terminals arranged in the remote device.

12. The multimode network communication system according to claim 3, wherein,
in the situation that the second equipment is wireless equipment, the multiple base station outdoor units are configure into at least one multi-antenna transmit diversity or multi-antenna receive diversity in the situation that there are multiple base station outdoor units.

13. The multimode network communication system according to claim 1, wherein, the remote devices are interconnected with each other in star, ring or net structure in the situation that there are multiple remote devices.

14. The multimode communication system according to claims 13, wherein the remote power supply units are connected with each other in the term of star, ring or shared bus in the situation that the remote devices each comprises the remote power supply unit.

15. The multimode network communication system according to claim 14, wherein the remote power supply units are adapted to provide backup connections to each other, and in the situation that any one of the base station outdoor units or wired terminals fails, the base station outdoor unit or wired terminal is supplied with power by an available remote power supply unit after power switchover from a failed remote power supply unit to an available remote power supply unit is completed.

16. The multimode network communication system according to claim 1, wherein the first equipment is wired equipment or wireless equipment.

17. The multimode network communication system according to claim 16, wherein:
in the situation that both the first equipment and the second equipment are wired equipment, the first equipment and the second equipment constitute a multimode wired network communication system;
in the situation that the first equipment is wired equipment and the second equipment is wireless equipment, or the first equipment is wireless equipment and the second equipment is wired equipment, the first equipment and the second equipment constitute a multimode wired and wireless network communication system; and
in the situation that both the first equipment and the second equipment are wireless equipment, the first equipment and the second equipment constitute a multimode wireless network communication system.

18. The multimode network communication system according to claim 2, wherein:
in the situation that the second equipment is wireless equipment, the local device comprises a power supply unit and a base station access processing unit, and the remote device comprises a base station outdoor unit; or the local device comprises the power supply unit and the remote device comprises the base station outdoor unit and the base station access processing unit; and
in the situation that the second equipment is wired equipment, the local device comprises the power supply unit and a wired access processing unit and the remote device comprises a wired terminal; or the local device comprises the power supply unit and the remote device comprises the wired terminal and the wired access processing unit.

19. The multimode network communication system according to claim 2, wherein, the remote devices are interconnected with each other in star, ring or net structure in the situation that there are multiple remote devices.

20. The multimode network communication system according to claim 2, wherein the first equipment is wired equipment or wireless equipment.
